(19) United States
(12) Patent Application Publication
(10) Pub. No.: US 2018/0283889 A1
(43) Pub. Date: Oct. 4, 2018

(54) NAVIGATION BASED ON USER INTENTIONS

(71) Applicant: Intel Corporation, Santa Clara, CA (US)

(72) Inventors: Nyuk Kin Koo, Bukit Mertajam (MY); Shao-Wen Yang, San Jose, CA (US); Brad Vrabete, Co. Clare (IE); Suraj Sindia, Hillsboro, OR (US)

(21) Appl. No.: 15/475,977

(22) Filed: Mar. 31, 2017

(51) Int. Cl. G01C 21/34; G01C 21/36

(52) U.S. Cl. CPC G01C 21/3484; G01C 21/3415; G01C 21/3608; G01C 21/362; G01C 21/3476; G01C 21/3691; G01C 21/3676; G01C 21/3611; G01C 21/3697

(57) ABSTRACT

Various systems and methods for generating navigation route plans based on user intents are described herein. A navigation system is disclosed that generates route plans based on user intents. The system includes a search engine for retrieving location data. The location data includes geolocations and location constraints associated with the geolocations. The system also includes an input device to receive selections of a plurality of geolocations and user intents corresponding to the plurality of geolocations. The system further includes a route generator to generate a route plan including a sequence of the plurality of geolocations. The sequence is based at least in part on comparing the user intents to location constraints associated with the plurality of geolocations. The system additionally includes a display device to present the route plan.

### TECHNICAL FIELD

Embodiments described herein pertain in general to navigation based on constraints and in particular to providing navigation routes based on user intentions.

### BACKGROUND

Conventional route planning solutions consider geolocation and traffic conditions. These conventional solutions seek to provide users with the fastest or shortest path to a desired destination. Traditionally, an optimal or best route is determined by a travel duration between a current location and the destinations or between subsequent destinations, the ordering of destinations being provided by a user. One issue with existing navigation systems is that they do not take into consideration the purpose of a user's visit to a destination when providing route planning. For example, with existing solutions, if a user inputs destinations A, B, C in order, there is no way for the user to request route planning based on certain constraints, such as, for example, business hours.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a flowchart illustrating a method for navigation by intention, according to an embodiment;

FIG. 2 is a flowchart illustrating a method for setting navigation constraints for locations, according to an embodiment;

FIG. 3 is a flowchart illustrating a method for generating a route plan based on constraints, according to an embodiment;

FIG. 4 illustrates an example user interface for searching for and selecting destination locations in a navigation application, according to an embodiment;

FIG. 5 illustrates an example user interface for selecting intentions in a navigation application, according to an embodiment;

FIG. 6 illustrates an example user interface for selecting shopping constraints in a navigation application, according to an embodiment;

FIGS. 7 and 8 illustrate example user interfaces for selecting dining constraints in a navigation application, according to an embodiment;

FIGS. 9 and 10 illustrate example user interfaces for selecting sightseeing constraints in a navigation application, according to an embodiment;

FIGS. 11 and 12 illustrate example user interfaces for selecting meeting or appointment constraints in a navigation application, according to an embodiment;

FIGS. 13 and 14 illustrate example user interfaces for selecting photography constraints in a navigation application, according to an embodiment;

FIGS. 15 and 16 illustrate example user interfaces for selecting a final destination in a navigation application, according to an embodiment;

FIGS. 17 and 18 illustrate example user interfaces for displaying route information with event reminders in a navigation application, according to an embodiment;

FIGS. 19 and 20 illustrate example user interfaces for displaying automatically re-ordered destinations in a navigation application, according to an embodiment;

FIG. 21 illustrates an example user interface for modifying a route in a navigation application, according to an embodiment; and

FIG. 22 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art, that the present disclosure may be practiced without these specific details.

Known navigation solutions do not include the ability to select a route to one or more destinations based on what the user intends to do at the destination(s). For instance, known navigation solutions typically plan a route from a geolocation to a destination based only on the shortest travel distance or time between the geolocation and the destination. These existing solutions may consider certain constraints such as traffic or road conditions. However, such solutions may fail to ensure that users achieve their purpose of visiting destinations in a route, particularly when there are multiple destinations that need to be sequenced or ordered based on the purpose of users' visits,

For example, with known navigation solutions, a user might either not realize there is a possibility of visiting the destinations (including stopovers or waypoints) in the order of B, A, and C, or the user may have to do trial and error to manually determine the possibility. The user may succeed in figuring out the optimal destination only after numerous, time consuming, and inefficient tryouts or attempts to manually determine an optimal route.

Consequently, one issue with known navigation solutions is that users may arrive at the locations in a least amount of time, but might miss the purpose of visits to certain destinations. Hence, to solve the above-noted issues and problems with known solutions, embodiments provide an optimized route in a per destination manner by exploring different orderings or sequencing of destinations based on specified constraints in order to optimize the user's needs.

A user's intentions or purposes for visiting a location are closely connected to when the user needs to visit the location. Using mechanisms described herein, user intentions are used to select optimal routes to destinations.

Systems and methods described herein implement a navigation application with an improved user experience by taking into consideration the purpose of a user's visit to destinations when planning a route and ordering destinations. For example, a user may input destinations A, B, C in order; however, the navigation application may receive selections from a user to request route planning based on certain location constraints, such as, for example, a location's business hours (some destinations may be stores or shops that are closed in the evening). In this way, embodiments improve upon traditional route planning solutions that do not take into account such user-centric constraints (i.e., user constraints).

Based on a user's input (e.g., destinations and the user's purposes for visiting the destinations), embodiments provide route planning solutions that determine an optimal or best route to ensure that the user arrives at each destination through a shortest path or shortest time while also satisfying the user's purposes or intents for visiting the destinations. In an embodiment, a system intelligently creates and modifies route plans to satisfy user intentions for visiting destinations. For example, embodiments create a route plan based on the user's intentions and calendar entries, and perform intelligent re-routing and re-ordering for a trip as user constraints corresponding to the user's intentions are triggered. In addition or alternative embodiments, techniques perform dynamic re-routing due to constraints such as traffic conditions, changes to appointments in a user's calendar application, changes to a user's mode of transport (e.g., changing from driving to walking), changes to the availability of other people at a location, and changing weather conditions.

In an embodiment, a route generator of a navigation system generates a route plan that includes an optimized route to a final destination via one or more other desired destinations where the route plan includes a sequence of the destinations that is based on a user's intentions (e.g., what the user intends to do at the destinations). In an embodiment, each of the user's intentions includes an objective and a purpose. According to this embodiment, the objective is a geolocation, such as a point of interest (e.g., an office location, a restaurant, a school, a household, a museum, or another location to be visited). The purpose includes a set of user constraints for achieving the objective. For example, a user intention for a destination may be shopping during business hours, sightseeing during daytime, visiting during non-peak hours on a weekday, and dining when a restaurant is serving dinner.

In some embodiments, the navigation system may receive user intentions from a variety of devices, such as, for example, an in-vehicle touchpad user interface as part of an advanced driver assistance system (ADAS), a touch screen in an autonomous driving vehicle, a device compliant with the CarPlay standard from Apple Inc., an in-vehicle microphone, a user's smartphone, a navigation device in a rental vehicle, or a chatbot in an autonomous driving vehicle. For instance, a user of an autonomous driving vehicle may interact with a user interface integrated into the autonomous driving vehicle (e.g., a microphone, touch screen, camera or other input device of the autonomous driving vehicle) to indicate intentions. In an embodiment, the navigation system determines an optimized or preferred route to the destinations by exploring different ordering of destinations based on user-specified constraints (i.e., user constraints) in order to optimize the user's intents or needs. The navigation system includes a route generator that automatically reorders the destinations based on the user's intention in order to optimize the user's needs. In an additional embodiment, the navigation system displays notifications when user constraints are triggered. For example, the navigation system may be integrated into an autonomous driving vehicle having an interactive user interface and an output device usable to display such notifications. According to this example, the autonomous driving vehicle may display the notifications on a touch screen display and optionally provide audio notifications via an audio output device such as, for example, the vehicle's speakers, head phone jacks, or Bluetooth audio devices.

According to an embodiment, the navigation system provides a route plan with an optimized route to a final destination via one or more other desired destinations based on intentions specified by a user. The user-specified intentions include points of interest and a set of user constraints for reaching the point of interests. In embodiments, the system is integrated into an autonomous driving vehicle that self-drives to the points of interest. The system orders or sequences the destinations in order to optimize meeting the intentions of the user. In embodiments, the navigation system is the navigation system of an autonomous driving vehicle that self-drives to the destinations in the determined order or sequence.

In an additional or alternative embodiment, the system modifies the route plan in real-time when the intentions of the user can no longer be satisfied. For example, the system may re-route the user so that the destinations are visited in a different order or sequence. Also, for example, the system may modify the route plan to remove a destination in response to determining that the user's intention for visiting the destination cannot be fulfilled (e.g., a store destination may be removed from the route plan if a location constraint indicates that the store has closed for the day). In an additional or alternative embodiment, the system displays notifications when the user-specified constraints (i.e., user constraints) are being triggered.

In some embodiments, systems and methods take multiple destinations as a whole into account and provide a route with an optimized ordering that satisfies the user's needs. For example, a mobile computing device may host a navigation application that takes all of a user's destinations for a trip into account when planning a route to the destinations, and sequence the destinations based on what the user intends to do at each destination (e.g., attending a class, meeting or appointment, shopping, dining, or sightseeing). Embodiments provide a navigation application with user interfaces that allow users to specify intentions, including not only their objectives, such as, for example, points of interest, but also their purpose. Various user constraints (e.g., desired arrival time, desired weather) and location constraints (e.g., dining hours, office hours, and business hours) are compared to ensure that a user's purpose for visiting a destination can be fulfilled. Subsequently, certain embodiments automatically re-order or re-sequence destinations based on a user's intention in order to optimize the user's needs.

According some embodiments, a user's intentions may include a list of destinations (e.g., interim destinations or waypoints) and one final destination. The user's intentions may also optionally include certain user constraints, such as, for example, preferred visit time(s), a time constraint for arriving at the final destination, respective priorities of the interim destinations, and a preference of a minimal travel time/distance.

In embodiments, without loss of generality, a user intention is defined in the context of navigation as a collection of one or more of the following:

(1) Objective: A point of interest, e.g., a store, a university, an airport, etc.;

(2) Purpose: A set of constraints for achieving a specific objective, e.g., shopping during a store's business hours, sightseeing during daytime, visiting during weekdays rather than weekend, etc.

A trip may include various intentions of a user, such as for example, intentions of a user of a mobile device or intentions of a user of an autonomous driving vehicle. According certain embodiments, intentions comprise objectives for a trip and purposes of a trip. In embodiments, a system and method may automatically suggest optimized or preferred routes for a user to follow in order to achieve the user's objectives and purposes. :For example, a navigation application executing on a computing device such as, for example, a smartphone, a laptop, a tablet device, or a navigation system, may display, on a display device, best routes for the user. To best meet a user's intents or intentions, a user's destination designated ‘optional’ may be dropped in the destination reordering process.

Embodiments provide advantages over conventional navigation solutions that do not take into account user intentions. For example, certain embodiments take into account user intentions that include objectives for a trip (e.g., go to specific geolocations) in addition to user intentions that include purposes (e.g., shopping during business hours of a store at one of the specific geolocations). Some embodiments reorder destinations in order to plan a route that may meet or satisfy a user's intention.

Conventional solutions only take into account objectives for traveling from geolocations (e.g., a user's current location) to destinations. However, a limitation of such conventional solutions is that by not taking a purpose of a trip into consideration, conventional solutions may suggest routes that are suboptimal and far from useful. In particular, without considering the purpose of a trip, a user may end up arriving at a point of interest such as a business, library, school, government office, or museum after the point of interest has closed; a user may end up going for night time sightseeing in the daytime; a user may end up planning to have lunch in a restaurant which does not open in the afternoon.

Systems and methods described herein provide navigation by intention. The systems and methods take as input a user's intents and generate routes that best meet the user's intents. The systems and methods provide advantages over conventional navigation solutions that only take into account destinations and their associated constraints (e.g., relatively static location constraints such as opening hours for a business at a destination). However, unlike conventional solutions that depend on geolocation that is static amongst users over time, embodiments take into account user constraints that depend on a user's intentions. User intentions can change from one user to another, from time to time, and from location to location.

In this document, the terms “intent” and “intention” shall be taken to include any reason, purpose, or intention for visiting a location. In an embodiment, an intent comprises a geolocation and a purpose. For example, a geolocation may be a restaurant and the purpose may be dining, picking up a carryout order, meeting someone at the restaurant's bar, or other reasons a person might have for going to the restaurant. Also, for example, a geolocation may be an office address and the purpose may be visiting a company gift shop, going to work, participating in a meeting, attending a conference or class, or other reasons a user may have for visiting an office. Further, for example, a geolocation may be a household and the purpose may be dropping off a package, visiting a friend, picking up a carpool member en route to work, dining at the household, returning home after work, or other purposes for visiting a home. User constraints may vary depending on intents (e.g., purposes) even if the geolocation/destination is the same. Location constraints such as a restaurant's dining hours and pick-up/carryout hours may vary; a company gift shop may be open from 9 AM-5 PM, whereas an office may be accessible at broader hours (e.g., 24/7); dropping off a package at a friend's household may be done at any time, but visiting a friend must be some time the friend is at home.

Embodiments provide navigation by intention, which includes several features not found in traditional navigation solutions. For instance, navigation by intention is user-centric and takes into account user constraints based on a user's intent rather than merely relying on geolocation's location constraints e.g., opening hours for a business). Further, navigation by intention may reorder or re-sequence destinations to best meet a user's intent, whereas conventional solutions perform only path planning based on traffic. Additionally, navigation by intention may reroute in real time as soon as a certain intent can no longer be satisfied (e.g., going to a household with a purpose of visiting a friend but the friend is no longer at home.)

In an embodiment, a navigation application receives input including a user's intents and any auxiliary information about the intents (e.g., a friend's real time location, a restaurant's real time dining hours and seating availability, a restaurant's real time pick-up or carry out hours, a hotel's parking hours, etc.). The navigation app may output a route plan that includes an ordering or sequence of geolocations (e.g., destinations or locations that the user desires to visit) and the corresponding routes from the user's current geolocation to the sequence of destinations.

In embodiments, user intents may be received from a variety of devices, such as, for example, an in-vehicle touchpad user interface as part of an ADAS, a device compliant with the CarPlay standard from Apple Inc., an in-vehicle microphone, a user's smartphone, a navigation device in a rental vehicle, or a chatbot in an autonomous driving vehicle. For example, an autonomous driving vehicle may receive user intents inputted via a user interface integrated into the autonomous driving vehicle (e.g., a microphone, touch screen, camera or other input device of the autonomous driving vehicle). Also, for example, a user may say “I want to visit friend A and go to work,” and an embodiment may respond with “going to work now and leave for friend A's house at 7 PM.” In an embodiment, user intents may also be inferred from a calendar application, such as, for example, Apple Calendar or Microsoft Outlook, and an embodiment may automatically order the destinations associated with the collection of intents and schedule specific routes with respective departure times.

In certain embodiments, security for any attributes or personal information about a user, or about the user's route plans, may be addressed by security mechanisms, such as, for example, an access control list (ACL). The present disclosure recognizes that the use of such personal information, in the disclosed embodiments, may be used to the benefit of users. For example, the personal information may be used to provide improved route plans that are more relevant to the user and enable a navigation application to satisfy the user's intentions for visiting destinations. Accordingly, the use of such personal information enables generation of route plans (e.g., by a route generator of a navigation system) that adhere to the user's reasons for visiting locations included in the route plans. Further, other uses for personal information that benefit the user are also contemplated by the present disclosure.

The present disclosure also contemplates that entities responsible for collecting, analyzing, disclosing, transferring, storing, or other use of such personal information data will comply with well-established privacy policies and/or privacy practices. In particular, such entities should implement and consistently use privacy policies and practices that are generally recognized as meeting or exceeding industry or governmental requirements for maintaining personal information private and secure. For instance, personal information from users should be collected for legitimate and reasonable uses of the entity and not shared or sold outside of those legitimate uses. Also, for example, such collection should occur only after receiving the informed consent of the user (e.g., the user of a navigation application). Further, such entities should take any needed steps for safeguarding and securing access to such personal information and ensuring that others with access to the personal information adhere to their privacy policies and procedures. Additionally, such entities may subject themselves to evaluation by third parties to certify their adherence to widely accepted privacy policies and practices.

Despite the foregoing, the present disclosure also contemplates embodiments in which users selectively block the use of, or access to, personal information. That is, the present disclosure contemplates that hardware and/or software elements may be provided to prevent or block access to such personal information. For example, in the case of a navigation application, embodiments may be configured to allow users to select to “opt in” or “opt out” of participation in the collection of personal information during installation and registration of the navigation application or as the application is being used. In another example, users may temporarily select not to provide geolocation information. In yet another example, users may select to not provide precise geolocation information, but permit the access to location zone information. In an additional example, users may selectively decline to provide their intentions or reasons for visiting destinations.

Therefore, although the present disclosure broadly covers use of personal information data to implement one or more various disclosed embodiments, the present disclosure also contemplates that the various embodiments may also be implemented without the need for accessing such personal information. That is, the various embodiments disclosed herein are not rendered inoperable due to the lack of all or a portion of such personal information. For example, route plans may be generated and displayed to users by inferring intents based on non-personal information or a bare minimum amount of personal information, such as the content being requested by a mobile computing device associated with a user, other non-personal information available to a navigation application, information from a calendar application, or publically available information.

### Example Methods:

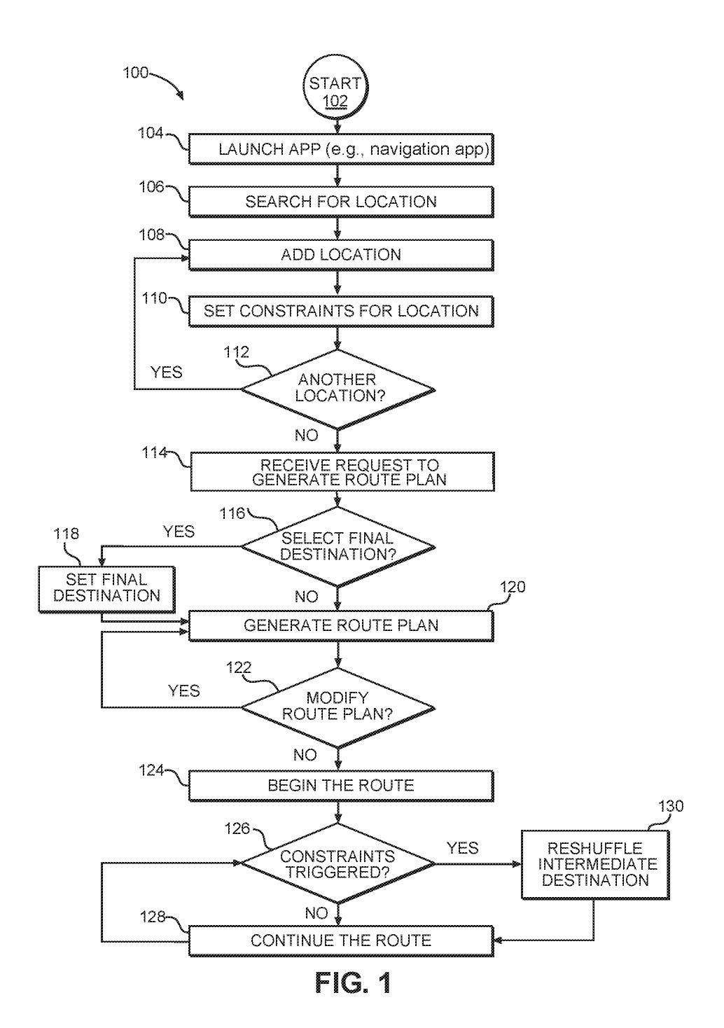

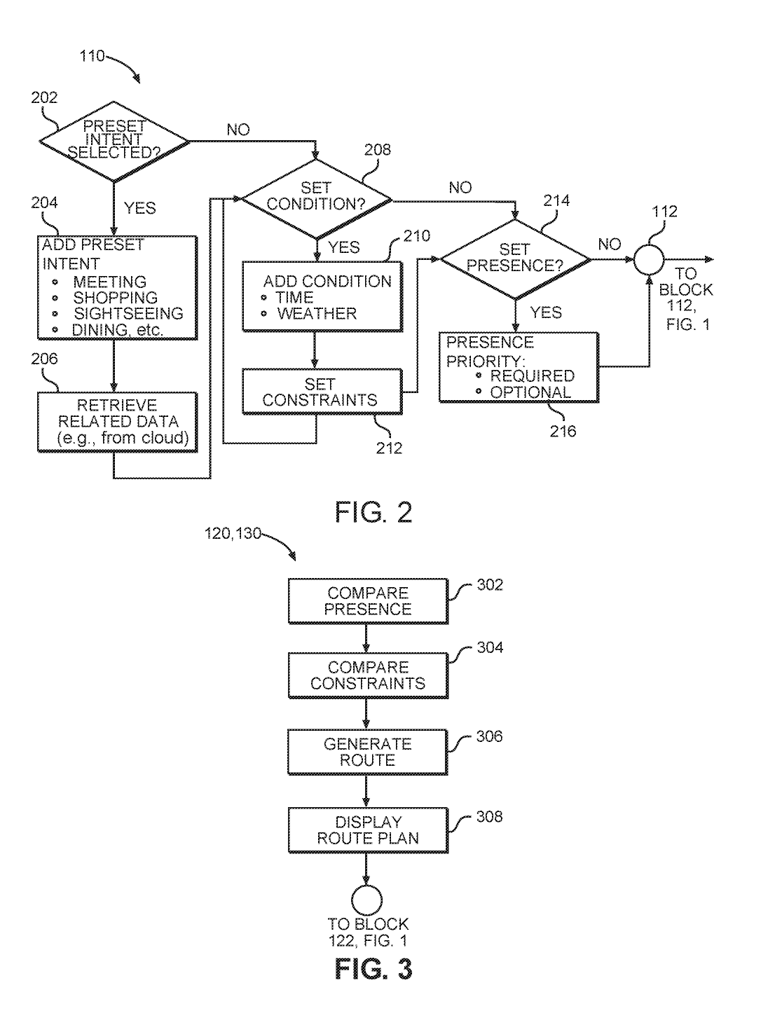

FIG. 1 is a flowchart illustrating a method 100 for navigation by intention, according to an embodiment. At block 102, the method 100 begins, and at block 104, an application is launched. In the example embodiment shown in FIG. 1, block 104 comprises launching a navigation application. In an embodiment, the app launched at block 104 is a mobile navigation app executing on a mobile computing device. In additional or alternative embodiments, the app launched at block 104 is a vehicle navigation app executing as part of a navigation system of an autonomous driving vehicle.

At block 106, a location search is performed. In an embodiment, block 106 is performed by a search engine configured to return one or more geolocations as search results. In an embodiment, the location search results returned by the search engine may include locations within a predefined radius from the user's current geolocation (e.g., a 20-mile radius around the user's current GPS coordinates). The location search performed by the search engine may be based on user input received via the navigation app. The location search may include accessing a database storing geolocations, points of interest associated with the geolocations, map data, and information related to roads and routes. In an embodiment, the search engine is configured to search and retrieve data from a network and the database for information related to gelocations within a certain radius of the user's current geolocation (e.g., a 20-mile radius around the user's current Global Positioning System (GPS) coordinates). In additional or alternative embodiments, the search engine is further configured to search and retrieve data from the network and the database for information related to geolocations in response to user input received via the navigation app. In embodiments, the user input may include text-based searches for destinations or points of interest near the user's current geolocation.

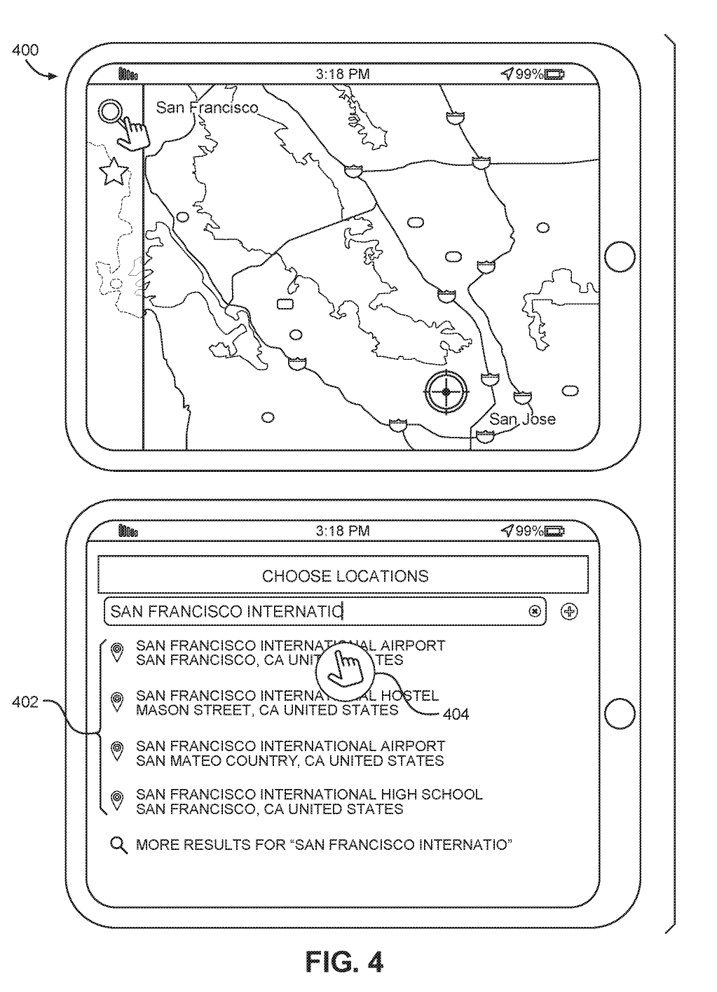

In additional or alternative embodiments, block 106 comprises invoking the search engine to search for locations in response to verbal input from a user (e.g., a user may speak location names into an audio capture mechanism such as a microphone). In an embodiment, the location search performed by the search engine may be initiated using the user interface shown in FIG. 4, which is described below. In an embodiment, using the audio capture mechanism comprises using a microphone to determine location names, and identifying a particular sound source that correlates with the voice of the user, and using the particular sound source to obtain audio data that corresponds to location search terms usable by the search engine.

According to some embodiments, block 106 comprises accessing, by the search engine, cloud-based storage or cloud-based services to search for locations. In an embodiment, the navigation app accesses the search engine to index web sites for information relevant to geolocations. Examples of such relevant information include current travel conditions, current weather conditions, social network data associated with geolocations (e.g., geo-tagged check-in data from friends and family), and opening hours for points of interest associated with geolocations. In an embodiment, the search engine is configured to index web sites on the Internet and networks coupled to the Internet, in order to obtain historical and real-time information related to geolocations.

At block 108, a location from the location search results from block 106 is added as a destination.

At block 110, user constraints are set for the added location. In embodiments, block 110 comprises selecting an intent for the added location and then setting one or more time constraints, weather constraints, and crowd (e.g., peak hours) constraints for the intent. In some embodiments, user constraints are set using the user interfaces of FIGS. 6-14, which are described below. Such user interfaces may be presented to the user by the navigation app as part of performing block 110.

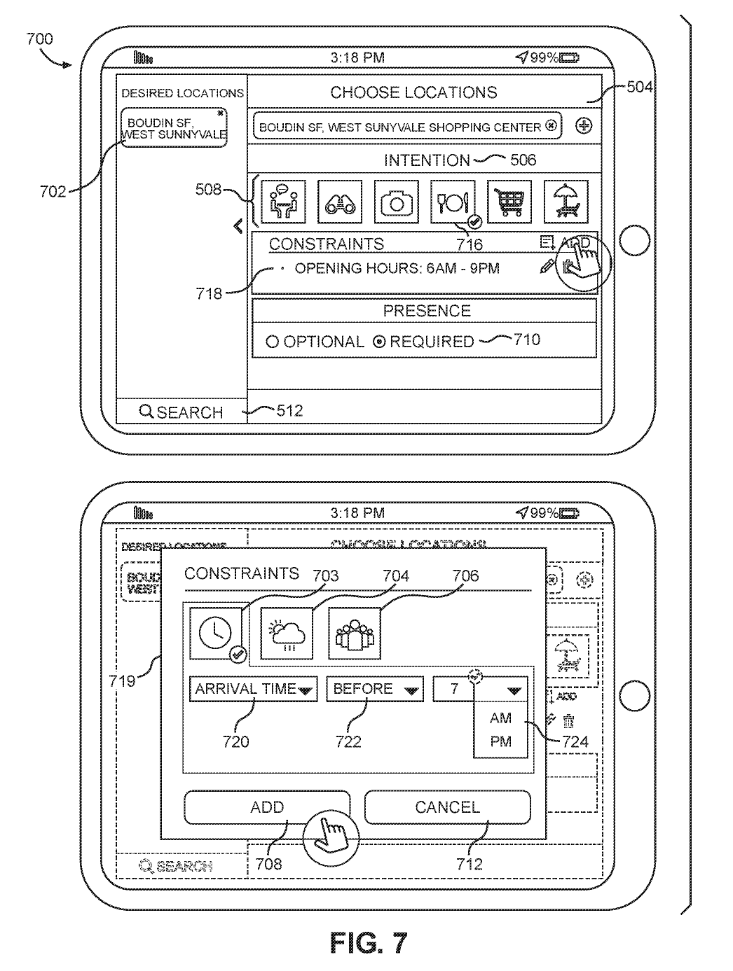

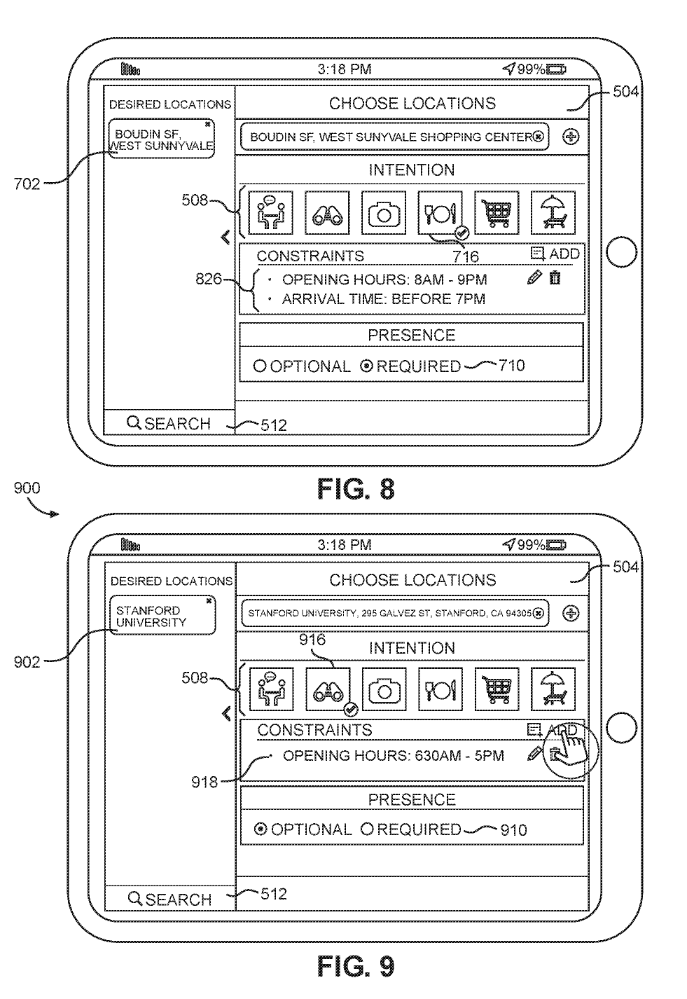

In an example embodiment, block 110 comprises selecting a shopping intent for a location and then setting a time constraint for a store at the selected location based on the store's opening hours. An example user interface for selecting a shopping intent is provided in FIG. 6. In another example embodiment, block 110 comprises selecting a dining intent for a location and then setting a time constraint for a restaurant at the selected location based on the restaurant's opening hours. Example user interfaces for selecting a dining intent is provided in FIGS. 7 and 8.

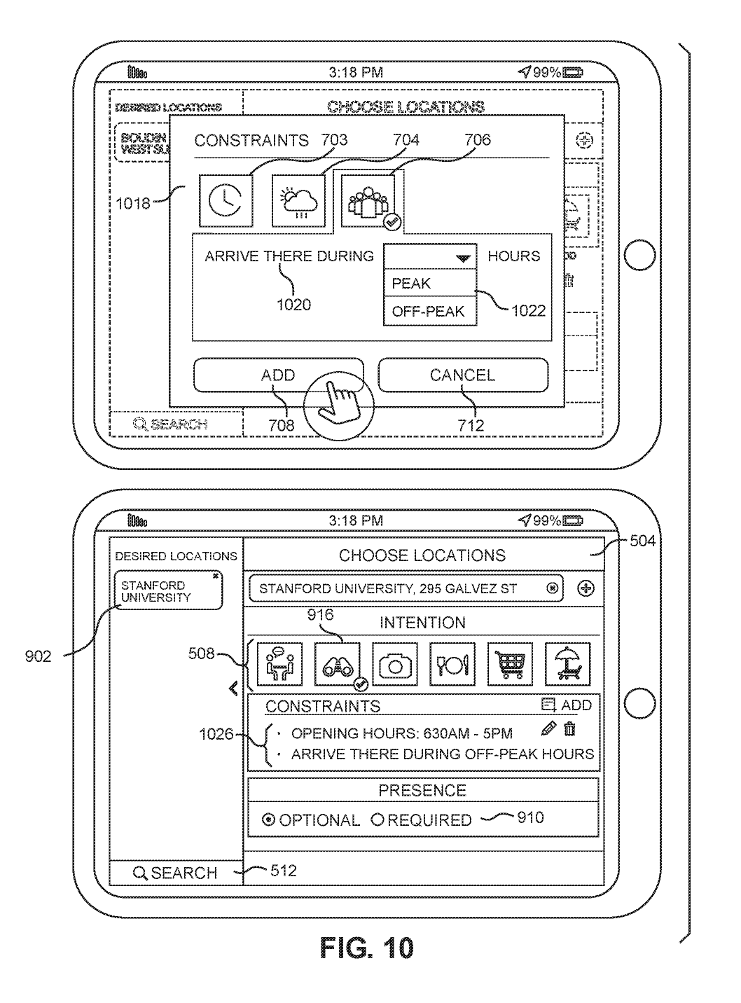

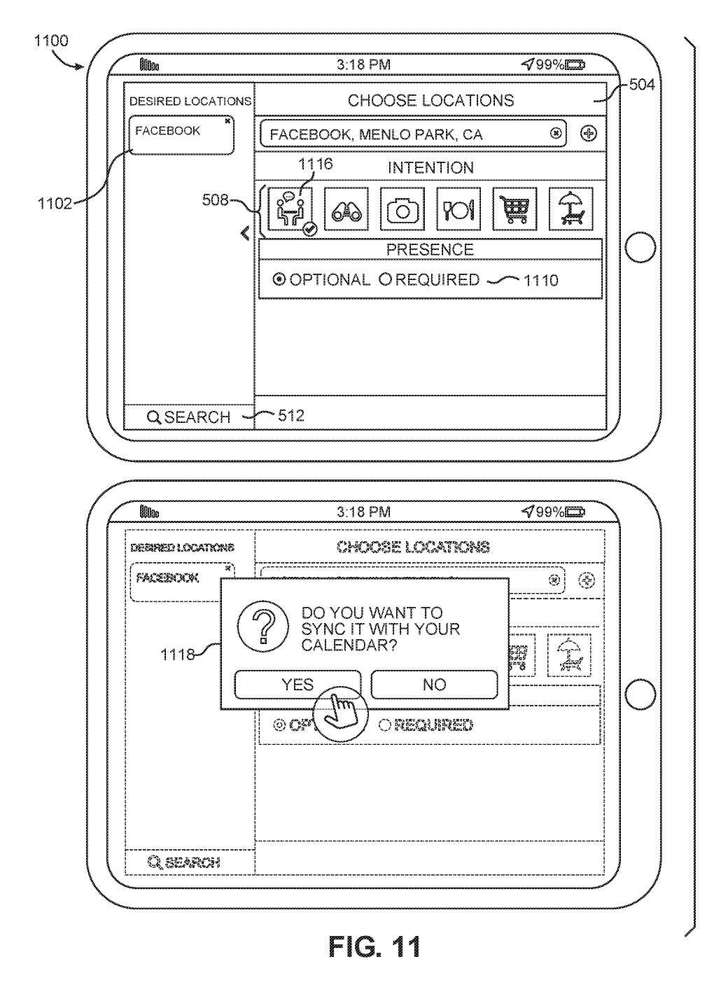

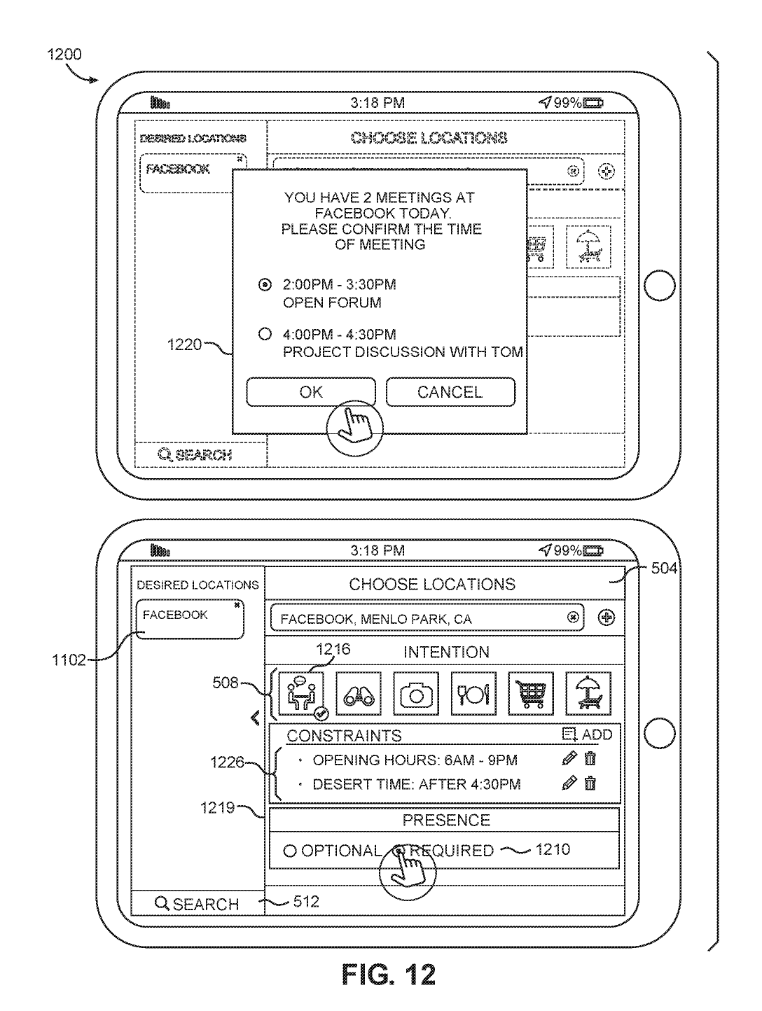

Further, in another example embodiment, block 110 comprises selecting a sightseeing intent for a location and then setting a peak hours constraint for a point of interest at the selected location based on the user's preferences (e.g., arrive at an off-peak time for sightseeing). Example user interfaces for selecting a dining intent is provided in FIGS. 9 and 10. In yet another example embodiment, block 110 comprises selecting an intention to attend a meeting or appointment at a desired location and then setting a user constraint based on a corresponding calendar event. For instance, a user interface may prompt the user to indicate whether they want to synchronize a meeting with the user's calendar. Example user interfaces for selecting a meeting intent are provided in FIGS. 11 and 12.

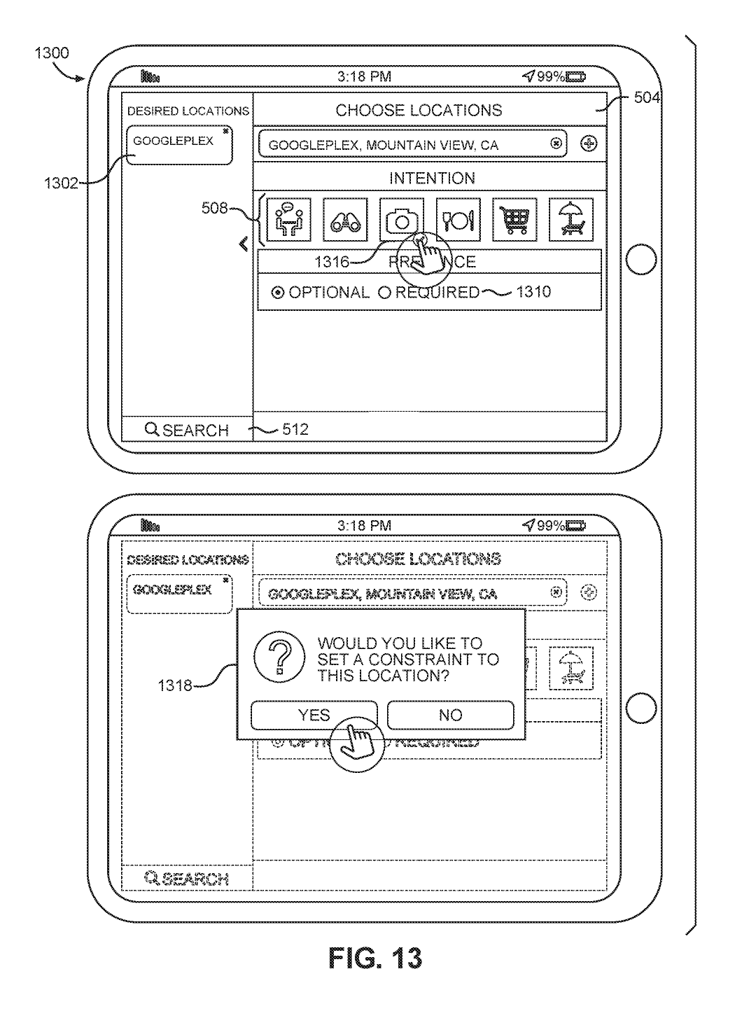

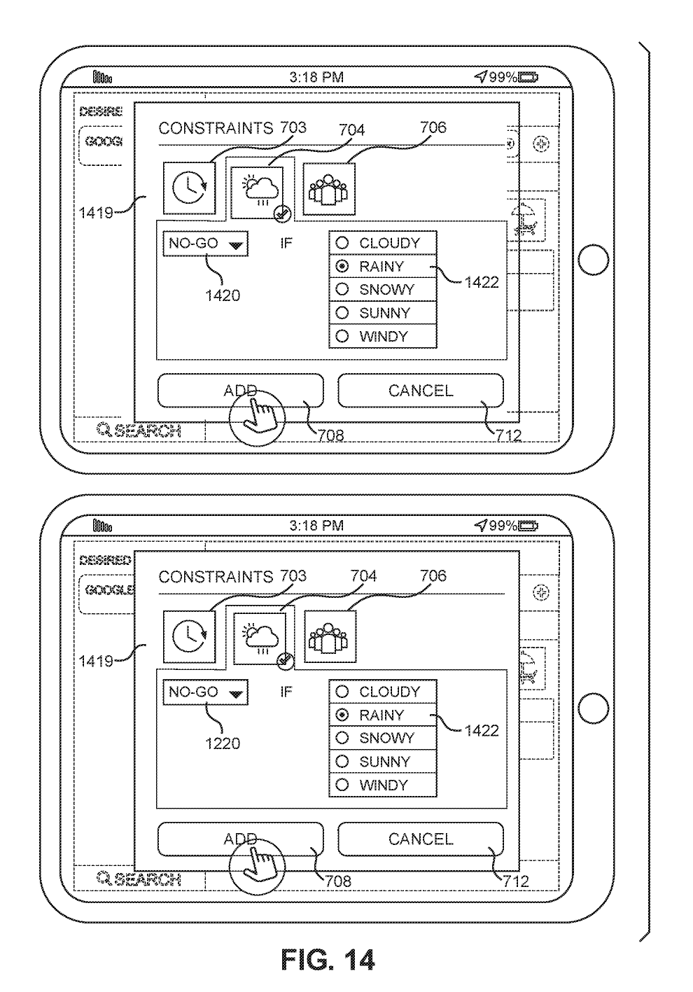

In an additional example embodiment, block 110 comprises selecting an intention to shoot photos or video at a desired location and then setting weather constraints indicating the user's preferred weather conditions for photography or videography (e.g., do not go if the weather is rainy). Example user interfaces for selecting a photography intent are provided in FIGS. 13 and 14.

Additional details and steps regarding how block 110 may be performed to set user constraints for locations are shown in the flowchart of FIG. 2, which is described below.

At block 112, a determination is made as to whether another location is to be added. If it is determined that there is another location to be added to the list of desired locations that the user wishes to include in a route, control is passed back to block 108. In an embodiment, block 112 comprises presenting the user interface shown in FIG. 4 so that the user may choose another location to be added as a desired location. Otherwise, if no additional locations are to be added to the route, control is passed to block 114.

At block 114, a request to generate a route plan is received. In an embodiment, block 114 comprises submitting a request for a route plan that includes the one or more desired locations selected by repeating blocks 108-112.

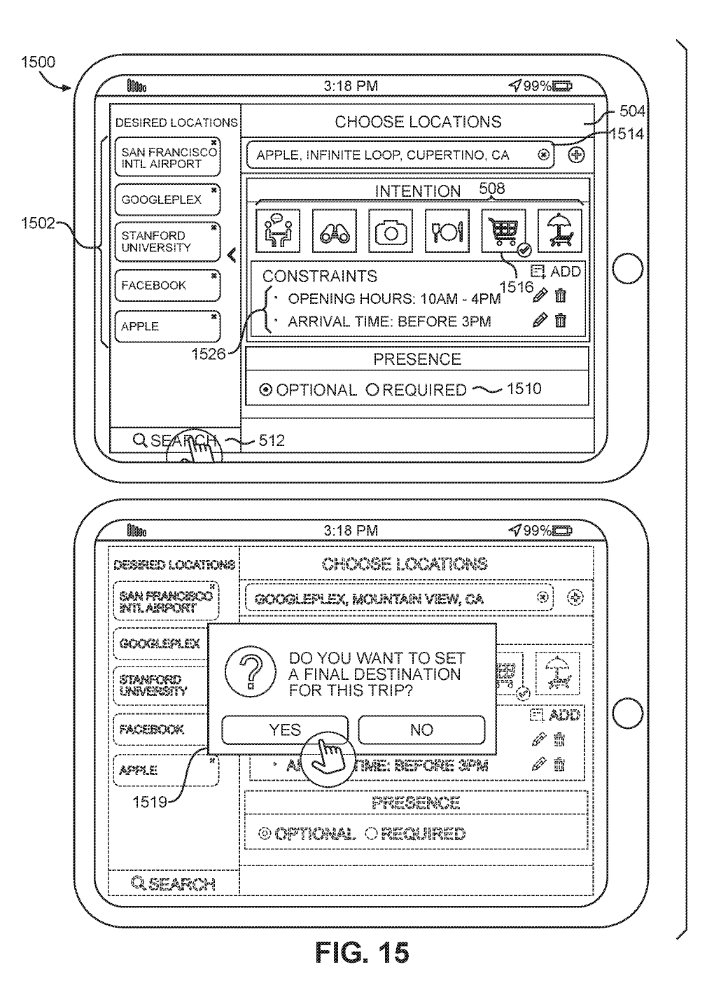

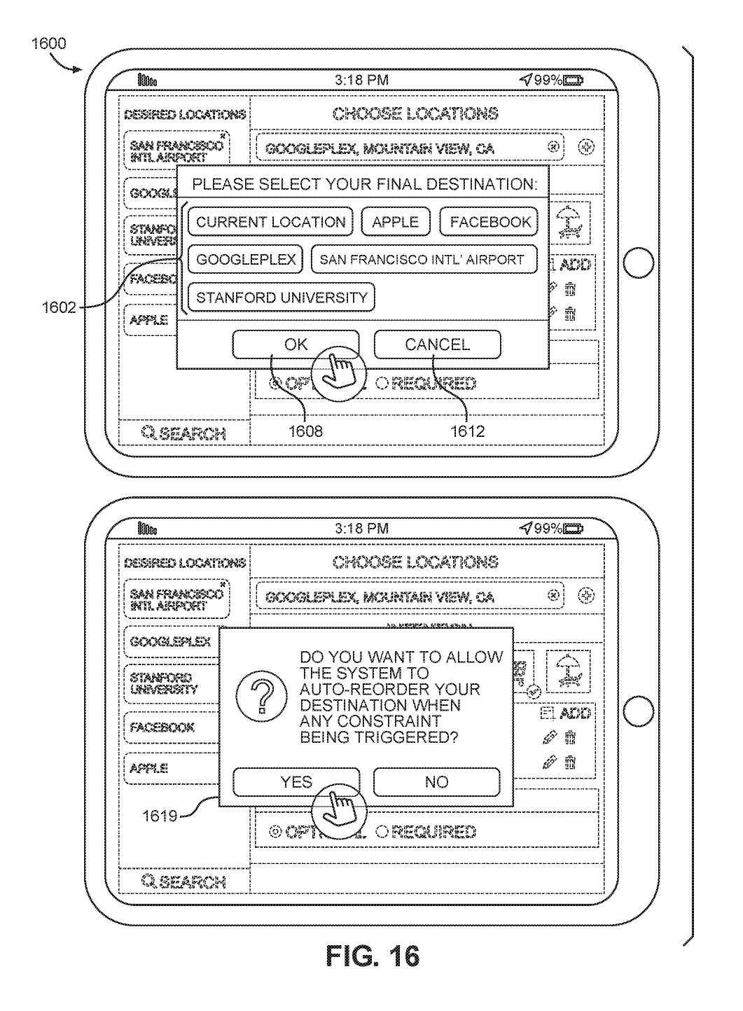

At block 116, a determination is made as to whether a final destination is selected. If it is determined that a final destination is selected, control is passed to block 118. For example, if a user explicitly selects a final destination from the list of desired locations, control is passed to block 118. In an embodiment, block 116 comprises a user selecting a destination from the list of desired locations where the selected destination that the user wishes to designate as the last stop in the route. In an embodiment, block 116 comprises presenting the user interfaces illustrated in FIGS. 15 and 16 so that the user may manually choose a location from amongst the desired locations to be the final destination for the route. Otherwise, if no final destination is selected for the route, control is passed to block 120 where the route plan is generated and a final destination is determined as a part of the route plan generation.

At block 118, the final destination selected at block 116 is set as the final destination in the route, and control is passed to block 120, where the route plan is generated.

At block 120, a route plan is generated. In an embodiment, block 120 comprises generating, by a route generator, a route to each of the list of desired locations in a defined sequence. In an embodiment, the route generator is configured to generate the route plan based on comparing the user constraints to the location constraints for the desired locations, and information retrieved by the search engine at block 106. According to an embodiment, if a final destination was set in block 118, block 120 comprises generating the route plan so that that final destination is last in sequence of the desired locations. Otherwise, block 120 may comprise the route generator generating the route plan with a final destination being automatically selected by the navigation app. In any event, block 120 may comprise generating the route plan so that the sequence of visits to the list of desired locations complies with the user constraints set at block 110. Additional details and steps regarding the generation of the route plan are shown in the flowchart of FIG. 3, which is described below.

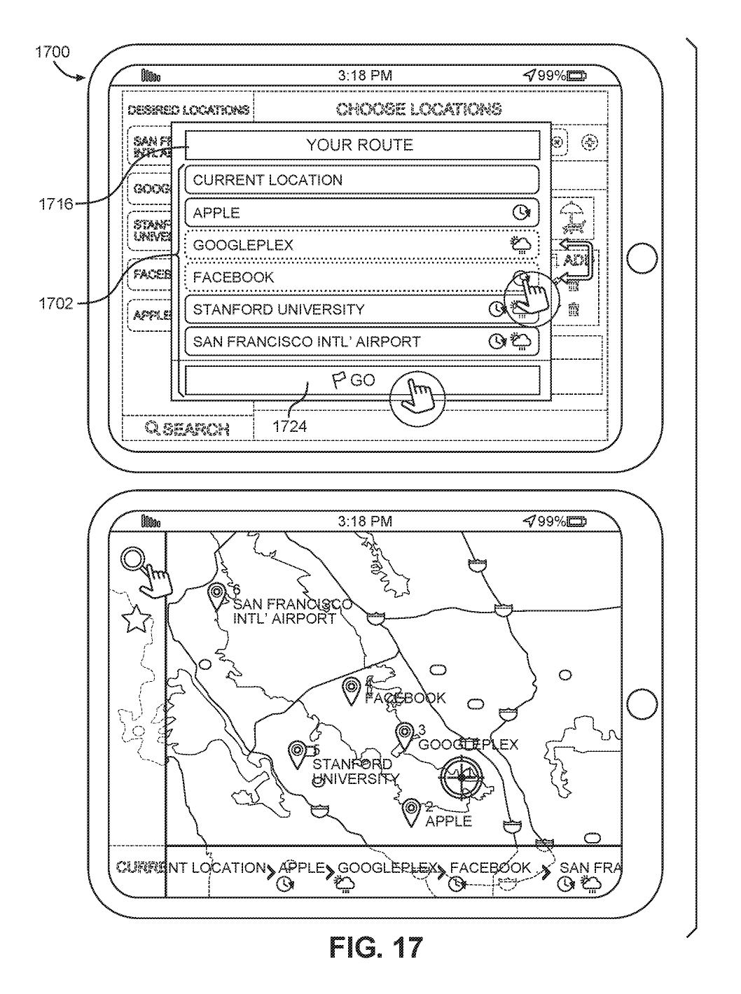

At block 122, a determination is made as to whether the route plan generated at block 120 is to be modified. If it is determined that the route plan is to be modified, control is passed back to block 120. In an embodiment, block 122 comprises presenting the user interfaces shown in FIGS. 17-19 so that the user may choose to manually re-order desired locations included in the route plan. In an embodiment, block 122 comprises automatically modifying the route plan to re-sequence desired locations in the route based on user constraints that are triggered before the route begins. For example, a route plan may be modified in response to comparing a location constraint, such as a store's closing time, to a user constraint such as a desired arrival time. Otherwise, if no modifications are to be made to the route, control is passed to block 124.

At block 124, the route begins according to the generated route plan. In embodiments, block 124 comprises presenting the map view user interfaces shown in FIGS. 17 and 19-21 so that the user may view the route and the destinations along the route as the user is on a trip. In an embodiment, block 124 comprises updating a map view of the route to indicate the user's current geolocation as the user progresses along the route.

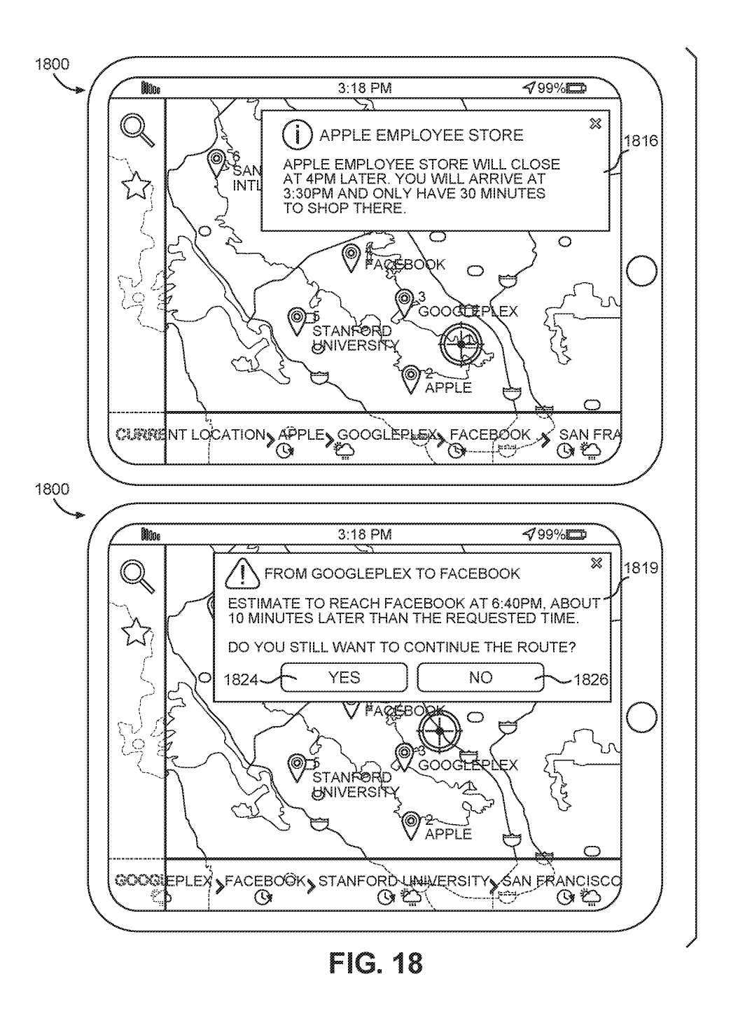

At block 126, a determination is made as to whether a user constraint is triggered. If it is determined that a user constraint has been triggered, control is passed to block 130. In an embodiment, block 126 comprises detecting if a user constraint set at block 110 for one or more desired locations in the route plan has been triggered. For example, block 126 may comprise comparing expected arrival times to time constraints and peak hours constraints, and comparing weather forecast data to weather constraints. In an embodiment, block 126 comprises presenting the user interface illustrated in FIG. 18 so that the user is notified when a constraint is triggered for a destination in the route. Otherwise, if no constraint is triggered, control is passed to block 128, where the route continues according to the existing route plan.

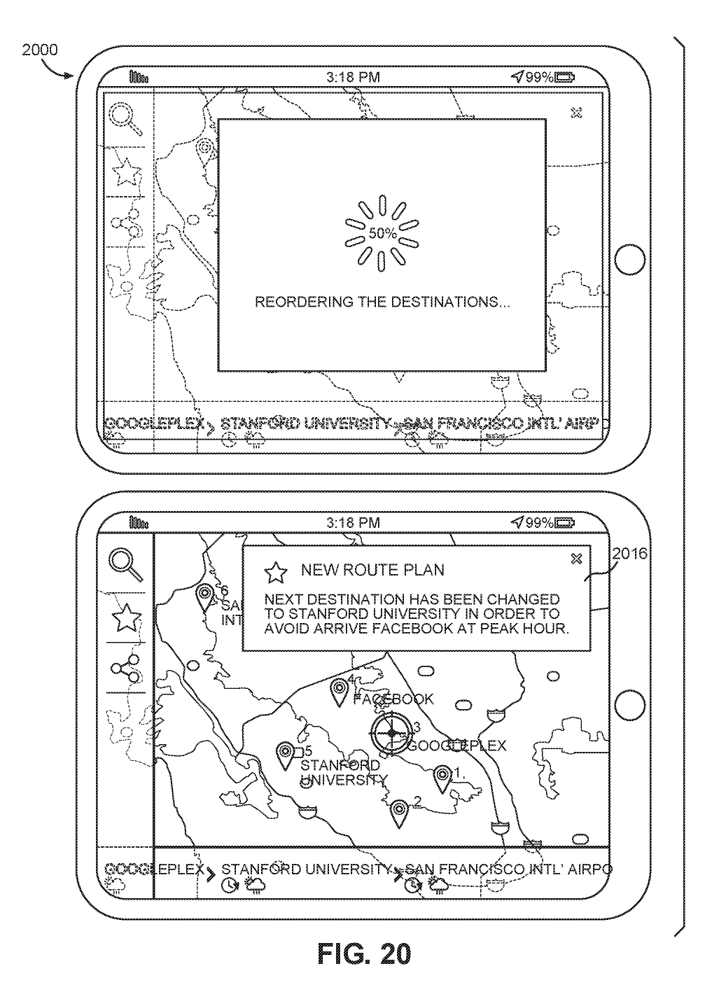

At block 130, an intermediate destination in the route plan is reshuffled based on a triggered user constraint (e.g., a constraint trigger that was detected in block 126). In one embodiment, a precursor to performing block 130 may include prompting the user as shown in FIG. 16 so that the user allows the navigation application to auto-reorder destinations in the route plan when a user constraint is triggered. In an embodiment, block 130 comprises automatically modifying the route plan to re-sequence desired locations in the route based on one or more triggered user constraints. In an embodiment, block 130 comprises presenting the user interface illustrated in FIG. 20 so that the user is presented with the modified route plan when a user constraint is triggered for a destination in the route.

FIG. 2 is a flowchart illustrating a method for setting user constraints for visiting locations, according to an embodiment. FIG. 2 corresponds to block 110 of FIG. 1 in more detail. In particular, the method of FIG. 2 includes example operations for setting conditions and user constraints corresponding to what a user intends to do at a desired location (e.g., setting one or more time constraints, weather-based constraints, and crowd/peak hours constraints for a user intent).

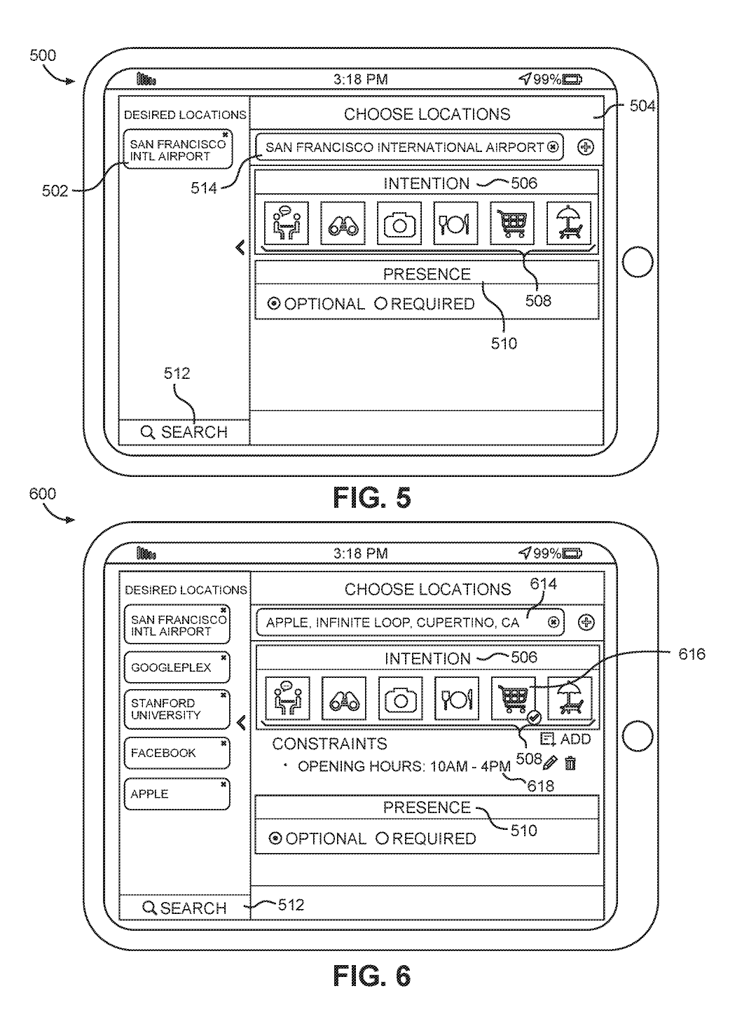

At block 202, a determination is made as to whether a preset intent is selected. If it is determined that a user selects a preset intent regarding what the user wishes to do at a location, control is passed to block 204. For example, if a user selects an icon corresponding to an intent from a set of preset intents, control is passed to block 204. In an embodiment, block 202 comprises detecting a user selection of one or more intent icons from a collection of preset intentions. In an embodiment, block 202 comprises presenting the user interface illustrated in FIG. 5 so that the user may manually choose an intent for a location from amongst the preset intents (e.g., meeting, sightseeing, photography, dining, shopping, and leisure/free time). Otherwise, if no intent is selected for a destination in the route, control is passed to block 208.

At block 204, the preset intent selected at block 202 is added. As shown in the example embodiment of FIG. 2, block 204 comprises adding one or more of a meeting intent, a shopping intent, a dining intent, and a sightseeing intent.

At block 206, data related to the added intent is retrieved. As shown in the example embodiment of FIG. 2, block 206 comprises retrieving the related data from a cloud-based data source or a cloud-based service. In embodiments, block 206 comprises retrieving weather forecast data related to weather constraints, retrieving crowd data related to peak hours constraints, and retrieving location constraints such as opening hours (e.g., for restaurants, offices, stores, museums, theaters, and other points of interest) related to time constraints.

At block 208, a determination is made as to whether a condition is set. If it is determined that a user wants to set a condition corresponding to an intention for what the user wants do at a location, control is passed to block 210. According to some embodiments, block 208 comprises detecting a user indication that a condition is to be set for an intent. In an embodiment, block 208 comprises presenting one or more of the user interfaces illustrated in FIGS. 6-14 so that the user may manually choose to set conditions for a preset intent. Otherwise, if no condition is set, control is passed to block 214.

At block 210, one or more conditions are added for the condition set in block 208. As shown in the example embodiment of FIG. 2, block 210 comprises adding a time condition and/or a weather condition. In an embodiment, block 210 comprises presenting the user interface shown in FIG. 7 so that a user may select one or more of a time icon, a weather icon, and a peak hours icon to add a time, weather, or peak hours condition. In additional or alternative embodiments, the user may also select an icon corresponding to a time to final destination constraint. In such embodiments, the user constraint for a time to final destination can also be set at block 210. Additional details of the time to final destination constraint are provided in the following paragraph with reference to block 212.

At block 212, user constraints are set. In an embodiment, block 212 comprises presenting the user interfaces shown in FIGS. 7, 10, and 14 so that a user may set one or more of a time constraint, a weather constraint, and a peak hours constraint to set a time, weather, or peak hours constraint. As discussed above, in additional or alternative embodiments, the constraints may also include at time to final destination constraint. According to such embodiments, block, 212 may comprise receiving a user setting for the time to final destination constraint where the time to final destination indicates a desired arrival time at a final destination in the route. In embodiments where the time to final destination constraint is set, when the user is on the route (e.g., driving or otherwise travelling along route), the navigation system may infer that a nearby desired location, such as, for example, a shop, is off-peak hours and will be of interest to the user, and then evaluate the time to final destination to determine if the nearby desired location can be visited without jeopardizing a desired arrival time at the final destination in the route. According to this example, the time to final destination constraint may be used by the navigation system to decide whether a recommendation or notification is presented to the user to ‘stop at nearby shop.’ For instance, real-time geolocation, traffic, and weather data can be evaluated by the navigation system in conjunction with the time to final destination constraint to determine if the stop at the nearby shop can be made without jeopardizing on-time arrival at the final destination in the route. If it is determined that there is sufficient time for the stop at the nearby shop, then the recommendation to stop at the nearby shop may be presented to the user. Otherwise, the recommendation is not presented.

At block 214, a determination is made as to whether a user wants to set a presence priority. If it is determined that a user wants to set a presence priority corresponding to an intention for what the user wants do at a location, control is passed to block 216. In an embodiment, block 214 comprises presenting the presence selection pane 510 depicted in FIG. 5 that includes buttons for indicating the importance of a user's presence at a destination or event (e.g., optional or required attendance in the example of FIG. 2). Otherwise, if no presence priority is to be set, the method ends (control is passed to block 112 of FIG. 1).

At block 216, a presence priority is set. As shown in the example embodiment of FIG. 2, block 216 comprises setting a user's priority or importance for a user's presence at a destination as either required or optional. In additional or alternative embodiments, other priorities may be set, such as, for example, a numerical range of priorities, or priorities ranging from required to preferred to observer to optional to unnecessary. After the presence priority is set, the method ends (control is passed to block 112 of FIG. 1).

FIG. 3 is a flowchart illustrating a method for generating a route plan based on user constraints, according to an embodiment. FIG. 3 corresponds to blocks 120 and 130 of FIG. 1 in more detail. In particular, the method of FIG. 3 includes example operations for generating a route to each of a list of desired locations in a defined sequence or order. In an embodiment, the method shown in FIG. 3 is performed by a route generator of a navigation system.

At block 302, a user's presence priority for a location is evaluated or compared to presence information associated with locations in the list of desired locations. In embodiments, presence priority (e.g., optional or required in the example interface shown in FIG. 5) is compared to presence information for other people who may be at the location. The comparison may also be based on scheduled or predicted presence information (e.g., comparing when the user is expected to be at a location for an appointment or meeting with data indicating when another person is expected to be at that location). In example embodiments, block 302 comprises comparing the user's presence priority to presence information for the user's friends, colleagues/coworkers, family members, service providers (e.g., doctors, dentists, professors, teachers, delivery people, drivers, workers), and other people the user may have an appointment with. In an embodiment, block 302 comprises comparing the user's presence priority to presence information from one or more of a cloud-based system, a cloud-based service, a social networking service (e.g., check-in data from friends and family), and a remote database.

At block 304, user constraints are compared to location constraints associated with the locations in the list of desired locations. In an embodiment, block 304 comprises comparing weather data for a location (e.g., real time weather conditions or weather forecast data) to a user's weather constraints for the location do not go to the location if it is rainy). In another embodiment, block 304 comprises comparing a projected arrival time for a location to a user's time constraints for the location (e.g., a user constraint to arrive at the location during a business's opening hours or a constraint to arrive at the location by a specified time for a meeting). In an embodiment, block 304 comprises comparing a user time constraint indicating a preferred arrival time to a location constraint indicating opening hours for a point of interest at a geolocation. For example, the comparison in block 304 may be based on the user's current geolocation, the user's mode of transport (e.g., driving, walking, biking, or public transit), and real time traffic conditions between the user's geolocation and the desired location in order to determine whether a user is likely to arrive by the user's preferred arrival time and during a business's opening hours.

At block 306, a route plan is generated (e.g., by a route generator). In an embodiment, block 306 comprises generating a route to each of the list of desired locations in a defined sequence. In embodiments, block 306 comprises generating the route plan based on the presence and constraint comparisons of blocks 302 and 304. For example, block 306 may comprise generating the route plan where a sequence of the desired locations and a final destination are automatically selected by the navigation app based on the presence and constraint comparisons performed in blocks 302 and 304. That is, block 306 may comprise generating the route plan so that the sequence of visits to the list of desired locations complies with the results of the presence and constraint comparisons at blocks 302 and 304, respectively.

At block 308, the route plan generated at block 306 is displayed. In embodiments, block 308 comprises presenting the map view user interfaces shown in FIGS. 17 and 19-21 so that the user may view the route and the destinations along the route as the user begins a trip. In additional or alternative embodiments, the route plan is displayed as a sequential list view of the ordered destinations in the route (see, e.g., the route list window 1716 of FIG. 17 that lists desired locations in the order that they appear in a route plan). As shown in FIG. 3, after the route plan is displayed, the method ends (control is passed to block 122 of FIG. 1).

### Example User Interfaces:

In FIGS. 4-21, various example user interfaces of a navigation application are depicted. In the non-limiting examples of FIGS. 4-21, the navigation application is a mobile navigation app executing on a mobile computing device (e.g., a smartphone or tablet device), as the user of the device interacts with the user interfaces to indicate user intentions. In additional or alternative embodiments, the navigation application is a vehicle navigation application executing on an autonomous driving vehicle.

Throughout FIGS. 4-21, the mobile computing device includes a touch-sensitive interface, such as a touch-sensitive display screen (also sometimes referred to as a touch screen), that may both display information to a user and also receive input from the user (e.g., input indicating the user's intentions regarding destinations).

In an embodiment, the user interfaces illustrated in FIGS. 4-21 are displayed on a mobile computing device that has a touch screen (e.g., a touch sensitive display device). For ease of explanation, the operations discussed in FIGS. 4-21 are in the context of a mobile navigation app executing on a mobile computing device (such as a tablet computing device with a touch-screen display device or a smartphone computing device with a touch-screen display device). However, the operations, user interfaces, and inputs shown in FIGS. 4-21 are not intended to be limited to the exemplary devices and platforms shown in FIGS. 4-21. It is to be understood that the navigation application and user interfaces illustrated in the exemplary embodiments of FIGS. 4-21 may be readily adapted to execute on displays of a variety of host computing device platforms running a variety of operating systems.

For example, the user interfaces illustrated in FIGS. 4-21 may be readily adapted to execute on a touch screen display of an autonomous driving vehicle configured to receive user selections of a plurality of geolocations and user intents corresponding to the geolocations. That is, the exemplary embodiments of FIGS. 4-21 may be a user interface of the autonomous driving vehicle. Such a user interface may include an output device used to present route plans and navigation-related notifications to a user of the vehicle. For example, the output device of the autonomous driving vehicle may include a display screen and an audio output device, such as the vehicle's speakers and headphone jacks. According to these examples, the user interface of the autonomous driving vehicle may include one or more of an in-vehicle touch pad, an in-vehicle touch screen, an in-vehicle microphone, an in-vehicle camera, and wireless devices paired with the autonomous driving vehicle. For instance, the user interface of the autonomous driving vehicle may include devices connected to the vehicle via wireless data networks (e.g., Bluetooth, Wi-Fi).

In accordance with embodiments, navigation instructions may be provided to a user via the graphical user interfaces illustrated in FIGS. 4-21. In FIGS. 4-21, travel in Silicon Valley is used to present scenarios that illustrate a user experience with user-centric interfaces of the example navigation app. As seen in FIGS. 4-21, user interfaces may include one or more controls and/or other regions that may display information to and/or receive input from a user of a navigation app. In particular, the various controls and/or other regions included in the user interfaces depicted in FIGS. 4-21 allow a user to indicate the user's intentions regarding planned visits to destinations. For instance, the various controls and/or other regions included in user interfaces shown in FIGS. 4-21 allow the user to define what the user's purpose is for visiting various destinations.

Throughout FIGS. 4-21, user interfaces and displays are shown with various icons, command regions, windows, panes, toolbars, menus, lists, dialog boxes, reminders, and buttons that are used to initiate action, invoke routines, search for locations, choose destinations, select intentions, provide user constraints, display location constraints, display route plans, or invoke other functionality. The initiated actions include, but are not limited to, searching for locations, choosing destinations from a list of locations, selecting intentions (i.e., indicating purposes for visiting locations), providing user constraints for intentions, displaying location constraints for destinations (e.g., opening hours of a destination), indicating the importance of a user's presence at a destination or event, and interacting with a navigation app via inputs and gestures. In certain embodiments, generation of a route plan to multiple destinations is substantially automated (e.g., by a route generator of a navigation system) so that the input required is a selection of the destinations and an indication of intentions (i.e., purposes of visiting the destinations). For brevity, only the differences occurring within FIGS. 4-21, as compared to previous or subsequent ones of the figures, are described below.

FIG. 4 illustrates an example user interface 400 for searching for and selecting destination locations in a navigation application. As shown, the user interface 400 includes a location search interface for searching for and selecting destination locations in the navigation application. In the example of FIG. 4, the user interface 400 is displayed on a computing device when a user of the computing device launches a navigation application (e.g., a navigation app on the user's smartphone). For instance, the user interface 400 may be the main page of a mobile navigation app that senses the user's current geolocation (e.g., by using a GPS to determine the current GPS coordinates of the user's mobile device or the user's vehicle). In some embodiments, the user's mobile device may be an onboard infotainment system of a vehicle. For example, the user's mobile device may be an onboard infotainment system including in-vehicle interactive displays and audiovisual input/output devices. In embodiments, the navigation app may be installed on a computing device such as, for example, a smartphone, a laptop, a tablet device, or a navigation system (e.g., a navigation system in communication with or integrated with a vehicle). For example, the navigation app may be integrated with an ADAS or an autonomous driving vehicle. As shown, the user interface 400 directs the user to a main page where the user interface 400 shows the current location of the user on a map.

With continued reference to FIG. 4, a user may make a selection 404 in order to add one or more desired locations to a list of locations 402. As shown in the non-limiting example of FIG. 4, the list of locations 402 may be displayed on the left side of the user interface 400.

FIG. 5 illustrates an example user interface 500 for selecting intentions in a navigation application. The user interface 500 includes a pane with a list of desired locations 502, a location selection bar 504, a currently selected location 514, an intention window 506, and a search button 512 to initiate a search (e.g., by a search engine). In response to receiving a selection of the search button 512, the user interface 500 may display a location search interface usable to search for additional locations to be listed in the list of desired locations 502.

As shown in FIG. 5, the intention window 506 includes a collection of preset intentions 508 and a presence selection pane 510, where the intentions 508 are presented as icons listed in an intention category. The presence selection pane 510 depicted in FIG. 5 includes buttons for indicating the priority or importance of a user's presence at a destination or event (e.g., optional in the example of FIG. 5). In response to receiving selection of an intention icon from the set of intentions 508, the navigation application may set user constraints based on the selection and the user's personal preferences. The user constraints may be used in route planning in order to determine relative priority of destination locations, the direction from one location to another and the best time to visit the locations.

FIG. 6 illustrates an example user interface 600 for selecting shopping constraints in a navigation application. As shown, the intentions 508 may include a shopping icon 616 that a user may select to indicate that the user intends to shop at a selected location 614. That is, by selecting shopping icon 616, a user may indicate an intention to shop at a destination. In an embodiment, in response to receiving a selection of the shopping icon 616, the shopping intention is associated with the selected location 614.

In an embodiment, after receiving a selection of the shopping icon 616, the navigation app may automatically retrieve and display the opening hours 618 of a store associated with the selected location 614 and set a time constraint for the selected location 614 based on the store's opening hours. In embodiments, the navigation app retrieves the opening hours 618 from one or more of a cloud-based system, a cloud-based service, a remote database, or a local data store on the mobile computing device that the navigation app is executing on. The navigation app may invoke a route generator to generate a route plan based, at least in part, on the store's opening hours 618.

FIGS. 7 and 8 illustrate example user interfaces for selecting dining constraints in a navigation application. In particular, FIG. 7 illustrates a user interface 700 that may be used to select a dining icon 716 in order to indicate a user intention to dine at a restaurant associated with a desired location 702. In response to receiving a selection of the dining icon 716, the navigation app may automatically set a time constraint based on the restaurant's opening hours 718. As shown, the user interface 700 may include a constraints window 719 usable to set additional constraints based on the user's intentions. The constraints window 719 includes a time icon 703, a weather icon 704, a peak hours icon 706, and time constraints menus 720, 722, and 724. The constraints window 719 also includes an add button 708 and a cancel button 712. The add button 708 may be selected to add a constraint and the cancel button 712 may be selected to cancel edits to a constraint.

As shown, in response to receiving a user selection of the time icon 703, the time constraints menus 720, 722, and 724 may be displayed. The user may interact with the time constraints menus 720, 722, and 724 to manually set their preferred arrival time (e.g., arrival time for dinner) as another user constraint in addition to the automatic constraint that is based on the restaurant's opening hours 718. For example, by selecting drop down values from time constraints menus 720, 722, and 724, the user may indicate a preferred arrival time (e.g., a constraint to arrive at the desired location 702 before 7 PM). The presence selection pane 710 depicted in FIGS. 7 and 8 includes buttons for indicating the importance of the user's presence at the restaurant (e.g., required in the example of FIGS. 7 and 8).

FIG. 8 depicts the results of a user's selections in the constraints window 719. In particular, FIG. 8 shows constraints 826 that include a location constraint that has been set based on the restaurant's opening hours 718 and a user constraint based on the user's preferred arrival time (e.g., a constraint to arrive at the restaurant before 7 PM).

FIGS. 9 and 10 illustrate example user interfaces for selecting sightseeing constraints in a navigation application. In particular, FIG. 9 illustrates a user interface 900 that may be used to select a sightseeing icon 916 in order to indicate a user intention to sightsee or tour a desired location 902. In response to receiving a selection of the sightseeing icon 916, the navigation app may automatically set a time constraint based on the opening hours 918 at the desired location 902. For instance, a constraint may be set automatically based on the opening hours 918 for a museum or art gallery associated with the desired location 902. That is, the user interface 900 shown in FIG. 9 may be used to select sightseeing icon 916 to indicate the user's intention to sightsee or tour at the desired location 902. The presence selection pane 910 depicted in FIGS. 9 and 10 includes buttons for indicating the importance of the user's presence at the desired location 902 (e.g., optional in the example of FIGS. 9 and 10).

As depicted in FIG. 10, in response to receiving selection of the sightseeing icon 916, the navigation app may display constraints window 1018 that is usable to set additional user constraints based on the user's intentions. The constraints window 1018 includes a time icon 703, a weather icon 704, a peak hours icon 706, and time constraints menus 1020 and 1022. The constraints window 1018 further includes an add button 708 and a cancel button 712. The add button 708 may be selected to add a user constraint and the cancel button 712 may be selected to cancel edits to a user constraint. As shown, in response to receiving a user selection of the peak hours icon 706, the time constraints menus 1020 and 1022 may be displayed. The user may select values from the time constraints menus 1020 and 1022 to manually set their preferred arrival time (e.g., an off-peak arrival time for sightseeing) as another user constraint in addition to the location constraint that is based on the opening hours 918. For example, by selecting drop down values from time constraints menus 1020 and 1022, the user may indicate a preferred arrival time (e.g., a user constraint to arrive at the desired location 902 during off-peak hours).

FIG. 10 also depicts the results of a user's selections in the constraints window 1018. In particular, FIG. 10 shows constraints 1026 including a location that has been set based on the opening hours 918 and a user constraint based on the user's preferred arrival time (e.g., a constraint to arrive for sightseeing during off-peak hours). By making selections from drop-down time constraints menus 1020 and 1022 in the constraints window 1018, the user may request that the navigation app generates a route plan so that the user arrives at the desired location 902 for a sightseeing tour during an off-peak hour. In this way, the constraints window 1018 is used to add an off-peak constraint.

FIGS. 11 and 12 illustrate example user interfaces for selecting meeting or appointment constraints in a navigation application. In particular, FIG. 11 illustrates a user interface 1100 that may be used to select a meeting icon 1116 in order to indicate a user intention to have a meeting or appointment at a desired location 1102. That is, the user interface 1100 shown in FIG. 11 may be used to select meeting icon 1116 to indicate the user's intention to attend a meeting or appointment at the desired location 1102.

The user interface 1100 includes a sync dialog 1118 prompting the user to indicate whether they want to synchronize a meeting with the user's calendar. In some embodiments, the meeting may be created as an appointment in one or more calendar applications. For example, the sync dialog 1118 may be used to indicate that a meeting should be synchronized with the user's scheduled appointments in the user's calendar. By interacting with the user interface 1100 shown in FIG. 11, a user may also reflect calendar appointments in a route plan generated by a route generator invoked by a navigation app. For example, any changes made to an appointment may be reflected in a new route plan (i.e., a modified route plan generated by the navigation app). In addition, a user may use presence selection pane 1110 to set the importance of their presence at the meeting or appointment.

FIG. 12 depicts a user interface 1200 with a meeting window 1220. In response to receiving a selection to synchronize a meeting with the user's calendar in the sync dialog 1118, the navigation app may automatically display the meeting window 1220 based on the user's calendar entries associated with the desired location 1102. For example, a user constraint may be set automatically based on the user's existing calendar entries (e.g., meetings or appointments) associated with the desired location 1102. This user constraint may be modified based on a selection received in the meeting window 1220. For instance, the user constraint may be modified in response to a user selecting a button in the meeting window 1220 to confirm the time of a meeting. The presence selection pane 1210 depicted in FIG. 12 includes buttons for indicating the importance of the user's presence at the meeting (e.g., required in the example of FIG. 12).

As depicted in FIG. 12, in response to receiving selection of the meeting icon 1116, the navigation app may display constraints window 1219 that is usable to set additional user constraints based on the user's intentions. FIG. 12 also depicts the results of a user's selections in the constraints window 1219. In particular, FIG. 12 shows constraints 1226 that include a location constraint that has been set based on opening hours and a user constraint that has been set based on selections made in the meeting window 1220. By making selections from the meeting window 1220, the user may request that the navigation app generates a route plan (e.g., by using a route generator) so that the user arrives at the desired location 1102 for a meeting at a scheduled time.

FIGS. 13 and 14 illustrate example user interfaces for selecting photography constraints in a navigation application. In particular, FIG. 13 illustrates a user interface 1300 that may be used to select a photography icon 1316. The photography icon 1316 may be selected to indicate a user's intention to take photos or shoot video at a desired location 1302.

In response to receiving a selection of the photography icon 1316, the navigation app may automatically display a dialog box 1318 prompting the user to indicate whether they want to set a user constraint for the desired location 1302. That is, the user interface 1300 shown in FIG. 13 may be used to select photography icon 1316 and the dialog box 1318 may be used to indicate the user's intention to set a constraint associated with shooting photos or video at the desired location 1302.

As depicted in FIG. 14, in response to receiving selection of the photography icon 1316 and receiving input in the dialog box 1318, the navigation app may display constraints window 1419 that is usable to set additional user constraints based on the user's intentions. The constraints window 1419 includes a time icon 703, a weather icon 704, a peak hours icon 706, and weather constraints menus 1420 and 1422. As shown, in response to receiving a user selection of the weather icon 704, the weather constraints menus 1420 and 1422 may be displayed. The user may interact with the weather constraints menus 1420 and 1422 to manually set their preferred weather conditions for photography (e.g., do not go if the weather is rainy) as a weather constraint. For example, by selecting drop down values from weather constraints menus 1420 and 1422, the user may indicate a preferred photography weather (e.g., a user constraint to go to the desired location 1302 only if the weather is sunny). That is, besides time and crowd constraints selectable using time icon 703 and peak hours icon 706, respectively, users may also select the weather icon 704 to set the weather constraint for certain circumstances. In the example of FIGS. 13 and 14, the user has indicated an intention to visit the desired location 1302 to capture photos if there is no rain. In an embodiment, the navigation app may use weather forecast data to plan the order of the desired location 1302 in the route; and also notify the user if the user constraint is triggered by comparing the user's weather constraint to real-time weather data during the user's trip.

FIGS. 15 and 16 illustrate example user interfaces for selecting a final destination in a navigation application. In particular, FIG. 15 illustrates a user interface 1500 with search button 512 that may be used to request, from a search engine, a search for locations. The user interface 1500 may also be used to request a route plan for visiting desired locations 1502. According to an embodiment, the navigation app may use a route generator to generate the route plan based on constraints 1526 and intentions 508 that have been selected for respective ones of the desired locations 1502. In the example of FIG. 15, the user has selected shopping icon 1516 to indicate that the user intends to shop at a selected location 1514, and the constraints 1526 include a location constraint based on the opening hours for a store associated with the selected location 1514 in addition to a user constraint indicating the user's preference to arrive at the store before 3 PM. The presence selection pane 1510 illustrated in FIG. 15 includes buttons for indicating the importance of the user's presence at the selected location 1514 (e.g., optional in the example of FIG. 15).

As shown in FIG. 15, in response to receiving a selection of the search button 512 (e.g., a tap input), the navigation app may automatically display a dialog box 1519 prompting the user to indicate whether they want to set a set a final destination from amongst the desired locations 1502.

FIG. 16 depicts a user interface 1600 that includes a destination selection menu 1602 that may be shown in response to receiving an indication in that the user wants to select their preferred final destination for the trip. The destination selection menu 1602 includes selectable buttons labeled with names of the desired locations 1502. The user may select one of these desired locations 1502 in the destination selection menu 1602, and then select OK button 1608 to set the selected location 1514 as the final destination for the trip. However, if the user selects cancel button 1612 in the destination selection menu 1602, or does not indicate that they want to set a set a final destination in dialog box 1519, the navigation app will automatically determine a final destination based on the constraints 1526, traffic conditions, and other criteria (e.g., respective geolocations of the desired locations 1502 and routes between the desired locations 1502).

As depicted in FIG. 16, the user interface 1600 also includes a dialog box 1619 prompting the user to indicate whether they want to allow the navigation app to automatically re-order a destination (e.g., one of the desired locations 1502) when a constraint (e.g., one of the location or user constraints included in constraints 1526) is triggered. Specifically, with reference to FIG. 15, in response to receiving an indication that the user wants destinations to be re-ordered based on user constraints, the navigation app may reorder destinations (i.e., re-sequence the order in which the route visits the desired locations 1502) based on the user's constraints in order to meet the user's selected intentions 508. For instance, the sequence in which a selected location 1514 is visited in a route plan may be changed based on the constraints 1526 for that location, the user's priority indicated in the presence selection pane 1510 (e.g., optional in FIG. 15), and the user's selected intention 508 (e.g., selection of the shopping icon 1516 as shown in FIG. 15). As part of the methods 100 and 300 described above with reference to FIGS. 1 and 3, a user's destination with a lower presence priority (e.g., optional instead of required) may be dropped from a route plan in order to best meet the user's intentions with regards to other destinations in a route plan.

FIGS. 17 and 18 illustrate example user interfaces for displaying route information with event reminders in a navigation application. In particular, FIG. 17 illustrates a user interface 1700 with a route list window 1716 that lists desired locations 1702 in the order that they appear in a route plan. Once the route plan is generated, the desired locations 1702 are displayed in the route list window 1716 in an ordered list.

As shown in FIG. 17, the user may modify the route plan by interacting with the route list window 1716 to change the sequence of desired locations 1702. In the example of FIG. 17, this may be done by swapping the order of rows in the route list window 1716 by dragging and dropping individual ones of the desired locations 1702. The route list window 1716 includes icons indicating any user constraints set for the desired locations 1702 (e.g., icons indicating arrival time constraints and weather constraints). These user constraints may have been set via user interactions with the user interfaces described above with reference to FIGS. 5-16. In an embodiment, location sequence changes for a location may only be made if there are no user constraints set on the location. Once the user is satisfied with the sequence of desired locations 1702 in the route list window 1716, the user may select a go button 172.4 to begin using the route plan.

FIG. 17 shows how the user interface 1700 displays a map view of the route plan in response to receiving a selection of the go button 1724. That is, by tapping on the go button 1724, the navigation app will navigate the user to all of the desired locations 1702 that are listed in the route list window 1716 (i.e., all locations that are in the route plan). In embodiments where the user interfaces of FIGS. 5-17 are displayed in an autonomous driving vehicle, selection of the go button 1724 causes the vehicle to autonomously drive to desired locations 1702 in the sequence indicated in the route list window 1716.

FIG. 18 illustrates a user interface 1800 including notifications that may be displayed if a user constraint is being triggered. According to embodiments, there are two types of notifications: (a) an event reminder 1816; and (b) a real-time decision request 1819. Event reminders 1816 are based on the user constraints that are set by users. With event reminders 1816, the navigation app may auto-detect an event, such as an event related to time constraints. Subsequently, the navigation app may display or send an event reminder to the user via a notification. For example, if the user has indicated a shopping intention, a notification may automatically be sent so that the user can avoid being late to a store.

The user interface 1800 also includes a real-time decision request 1819. With the real-time decision request 1819, an instant notification is presented to the user with a yes button 1824 and a no button 1826. The user may select these buttons for decision-making regarding continuing with the planned route (or not) in response to a prompt in the real-time decision request 1819. The real-time decision request 1819 may be displayed when a user constraint that is set on the location is triggered. In additional or alternative embodiments, event reminders 1816 and real-time decision requests 1819 may be transmitted or sent to the user instead of or in addition to being displayed. For instance, event reminders 1816 may be sent to the user as SMS text messages, audio alerts at the user's smartphone, or email messages. With these two types of notifications, the purpose of a user's visit to each of the locations in a route plan may be easily assisted by the navigation app.

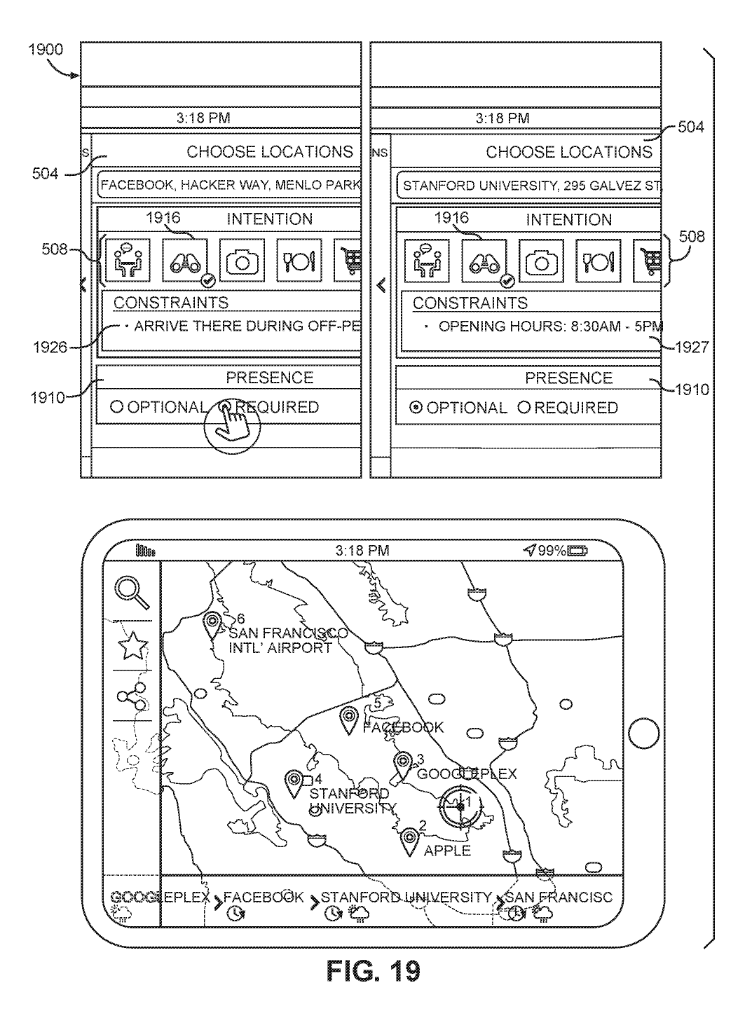

FIGS. 19 and 20 illustrate example user interfaces for automatically re-ordering destinations in a route plan and displaying the re-ordered destinations in a navigation application. In particular, FIG. 19 illustrates a user interface 1900 that illustrates how a sequence of destinations may be automatically re-ordered in response to a constraint 1926 being modified. As shown, the user constraint 1926 is a user's time constraint related to sightseeing at a destination (a sightseeing icon 1916 is selected from intentions 508). The user interface 1900 may display a map view of a route that indicates a current sequence of destinations before the user constraint 1926 is changed from a peak hours constraint to arrive during off-peak hours to a location constraint 1927 to merely arrive during opening hours of a destination. This map view of the route is updated in the user interface 2000 shown in FIG. 20. FIGS. 19 and 20 also show how destinations may be re-ordered when user input in a presence selection pane 1910 indicates the user's priority for presence at a destination has changed (e.g., changed from required to optional in the example of FIG. 19). The user interface 2000 includes an indication that the destinations are being re-ordered, and a resulting updated map view displaying the re-ordered destinations. In the example of FIGS. 19 and 20, the sequence of destinations 4 and 5 is re-ordered in response to changes in from the user constraint 1926 to the location constraint 1927, and a change in the user's priority for presence.

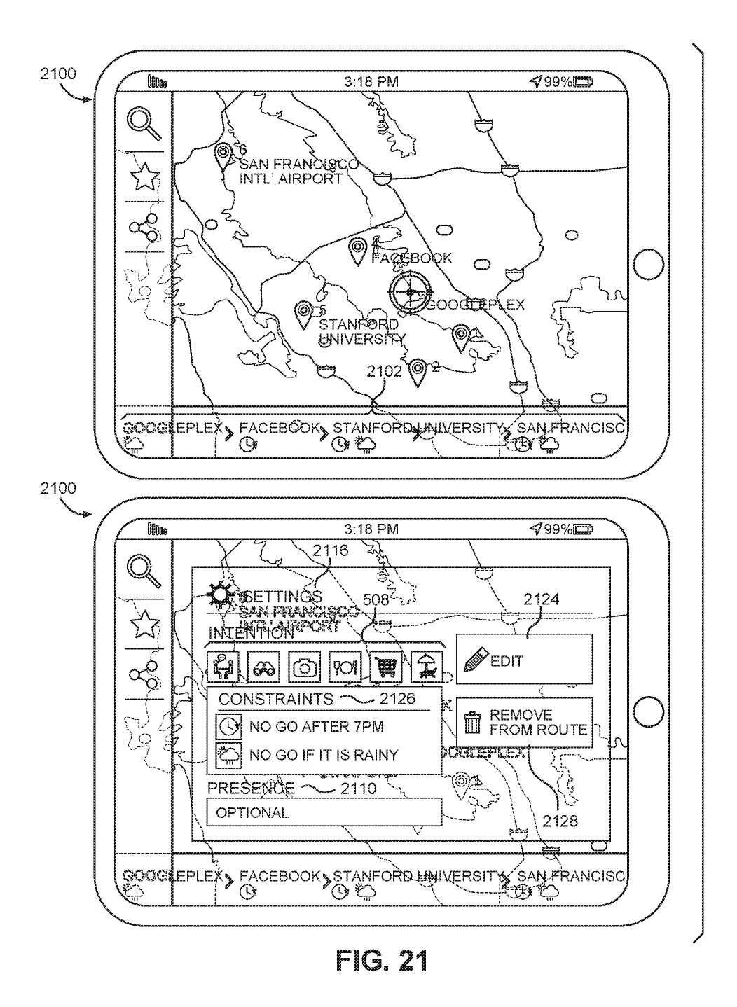

FIG. 21 illustrates an example user interface 2100 with a settings window 2116 for modifying a route in a navigation application. As shown, the settings window 2116 includes icons for intentions 508, a presence selection pane 2110, an edit button 2124, editable user constraints 2126, and a remove button 2128. In an embodiment, the settings window 2116 for a destination may be displayed in response to receiving a selection on a location name 2102 (e.g., a long tap on the location's name at the bottom of user interface 2100). By selecting the edit button 2124, the user may change the importance of the user's presence at a destination (e.g., optional in the example of FIG. 21) and change user constraints 2126 associated with a purpose for visiting the destination. By selecting the remove button 2128, the user may remove the destination from the route plan.

### Example Computer System Implementations:

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such, modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

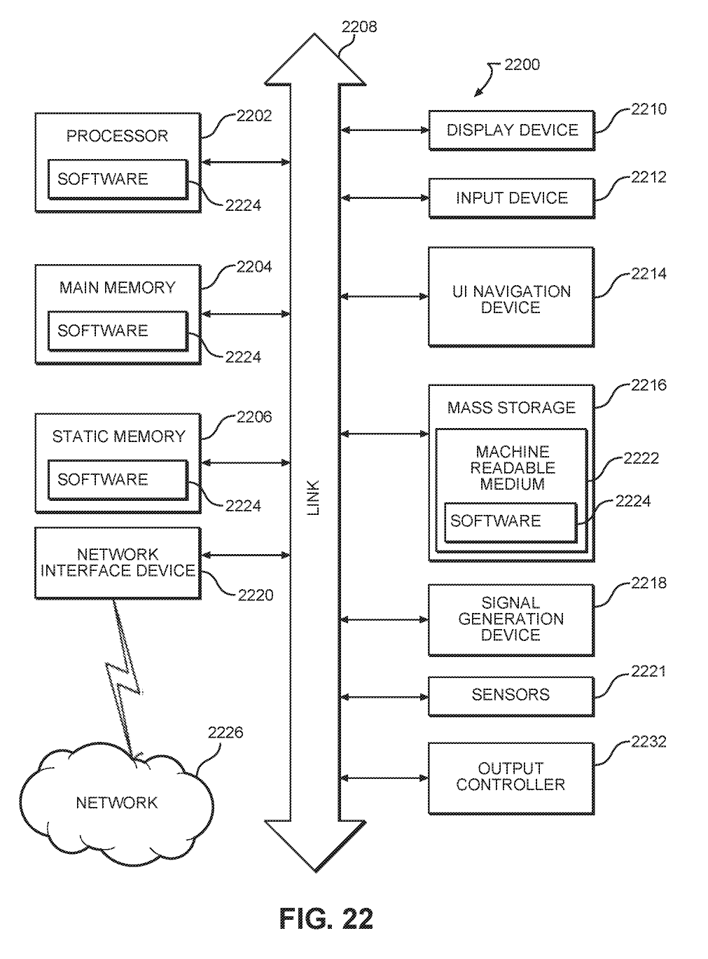

FIG. 22 is a block diagram illustrating a machine in the example form of a computer system 2200, within which a set or sequence of instructions may be executed to cause the machine to perform any one of the methodologies discussed herein, according to an example embodiment. For example, the methods described above with reference to FIGS. 1-3 may be performed using the computer system 2200.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, an ADAS, an apparatus of an autonomous driving vehicle, a wearable device, a personal computer (PC), a tablet PC, a hybrid tablet, a personal digital assistant (PDA), a mobile telephone (e.g., a smartphone), or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein. For instance, the computer system 2200 may execute instructions to perform the methods described above with reference to FIGS. 1-3. Also, for example, the computer system 2200 may execute instructions to perform navigation for an autonomous driving vehicle. That is, the computer system 2200 may be an onboard vehicle system of an autonomous driving vehicle.

Example computer system 2200 includes at least one processor 2202 (e.g., a central processing unit (CPU), a graphics processing unit (GPU) or both, processor cores, compute nodes, etc.), a main memory 2204 and a static memory 2206, which communicate with each other via a link 2208 (e.g., bus). The computer system 2200 may further include a video display device 2210, an input device 2212 (e.g., an alphanumeric input device such as keyboard or keypad, a touchpad, a microphone, a camera, or components of a virtual reality/VR headset such as buttons), and a user interface (UI) navigation device 2214 (e.g., a mouse, a stylus, or a pointing device). In one embodiment, the video display device 2210, input device 2212 and UI navigation device 2214 are incorporated into a touch screen display (e.g., a touch sensitive display device). In an embodiment, the user interfaces described above with reference to FIGS. 4-21 may be displayed on the video display device 2210.

The computer system 2200 may additionally include a storage device 2216 (e.g., a drive unit), a signal generation device 2218 (e.g., a speaker), a network interface device 2220, and one or more sensors 2221, such as a global positioning system (GPS) sensor, a compass, an accelerometer, a gyrometer, a magnetometer, or other sensors. The computer system 2200 may also include an output controller 2232, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the processor 2202 and/or instructions 2224 (e.g., software in the example shown in FIG. 22) comprises processing circuitry and/or transceiver circuitry.

The storage device 2216 includes a machine-readable medium 2222 on which is stored one or more sets of data structures and instructions 2224 (e.g., software) embodying or utilized by any one or more of the methodologies or functions described herein. For example, the computer system 2200 may execute instructions 2224 to perform the methods described above with reference to FIGS. 1-3.

The instructions 2224 may also reside, completely or at least partially, within the main memory 2204, static memory 2206, and/or within the processor 2202 during execution thereof by the computer system 2200, with the main memory 2204, static memory 2206, and the processor 2202 also constituting machine-readable media 2222.

While the machine-readable medium 2222 is illustrated in an example embodiment to be a single medium, the term “machine-readable medium” may include a single medium or multiple media (e.g., a centralized or distributed database, and/or associated caches and servers) that store the one or more instructions 2224. The term “machine-readable medium” shall also be taken to include any tangible medium that is capable of storing, encoding or carrying instructions 2224 for execution by the machine and that cause the machine to perform any one or more of the methodologies of the present disclosure or that is capable of storing, encoding or carrying data structures utilized by or associated with such instructions 2224. The term “machine-readable medium” shall accordingly be taken to include, but not be limited to, solid-state memories, and optical and magnetic media. Specific examples of machine-readable media 2222 include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 2224 may further be transmitted or received over a communications network 2226 using a transmission medium via the network interface device 2220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The network interface device 2220 may transmit and receive data over a transmission medium, which may be wired or wireless (e.g., radio frequency, infrared or visible light spectra, etc.), fiber optics, or the like, to network 2226.

Network interface device 2220 according to various embodiments may take any suitable form factor. In one such embodiment, network interface device 2220 is in the form of a network interface card (NIC) that interfaces with processor 202 via link 208. In one example, link 208 includes a PCI Express (PCIe) bus, including a slot into which the NIC form-factor may removably engage. In another embodiment, network interface device 2220 is a network interface circuit laid out on a motherboard together with local link circuitry, processor interface circuitry, other input/output circuitry, memory circuitry, storage device and peripheral controller circuitry, and the like. In another embodiment, network interface device 2220 is a peripheral that interfaces with link 208 via a peripheral input/output port such as a universal serial bus (USB) port.

### EXAMPLES

Example 1 is a navigation system for generating a route plan based on user intents, the system comprising: a search engine for retrieving location data, the location data including geolocations and location constraints associated with the geolocations; an input device to receive selections of a plurality of the geolocations and user intents corresponding to the plurality of geolocations; a route generator to generate a route plan including a sequence of the plurality of geolocations, wherein the sequence is based at least in part on comparing the user intents to constraints associated with the plurality of geolocations; and a display device to present the route plan.

In Example 2, the subject matter of Example 1 optionally includes wherein each of the user intents comprises a geolocation and a purpose for visiting the geolocation.

In Example 3, the subject matter of Example 2 optionally includes wherein a purpose for visiting a geolocation comprises one or more of shopping, dining, sightseeing, photography, attending an appointment, and participating in a meeting.

In Example 4, the subject matter of any one or more of Examples 1-3 optionally include wherein the location data further includes points of interest associated with the geolocations, and wherein the location constraints include opening hours of the points of interest.

In Example 5, the subject matter of any one or more of Examples 1-4 optionally include wherein each of the user intents comprises a geolocation and a user constraint for visiting the geolocation.

In Example 6, the subject matter of Example 5 optionally includes wherein a user constraint for visiting a geolocation comprises one or more of a time constraint, a weather constraint, a presence constraint, a peak hours constraint, and a time to final destination constraint.

In Example 7, the subject matter of Example 6 optionally includes wherein a presence constraint indicates whether a person's presence at the geolocation is required or optional.

In Example 8, the subject matter of any one or more of Examples 6-7 optionally include wherein a peak hours constraint indicates whether a geolocation is to be visited during peak hours or off-peak hours.

In Example 9, the subject matter of any one or more of Examples 6-8 optionally include wherein a time constraint indicates whether an arrival time at a geolocation should be at, before, or after a specified time.

In Example 10, the subject matter of any one or more of Examples 6-9 optionally include wherein a weather constraint indicates a desired weather condition for visiting a geolocation.

In Example 11, the subject matter of any one or more of Examples 6-10 optionally include wherein a time to final destination indicates a desired arrival time at a final destination in the route.

In Example 12, the subject matter of any one or more of Examples 1-11 optionally include wherein the search engine retrieves the location data in response to location search terms received via the input device.

Example 13 is a method for navigation based on user intents, the method comprising: retrieving location data including geolocations and location constraints associated with the geolocations; receiving selections of a plurality of the geolocations and user intents corresponding to the plurality of geolocations, generating a route plan including a sequence of the plurality of geolocations, wherein the sequence is based at least in part on comparing the user intents to location constraints associated with the plurality of geolocations; and presenting the route plan to a user.

In Example 14, the subject matter of Example 13 optionally includes after the presenting: determining whether one or more of the user intents cannot be satisfied by comparing the user intents to the location constraints associated with the plurality of geolocations; modifying the route plan in real-time in response to determining that one or more of the user intents cannot be satisfied, wherein the modifying includes modifying the sequence of the plurality of geolocations; and presenting the modified route plan to the user.

In Example 15, the subject matter of any one or more of Examples 13-14 optionally include after the presenting: modifying the route plan in real-time in response to detecting a change in one or more of a traffic condition, an appointment in a calendar application, the user's mode of transport, availability of people at a location, and a weather condition, wherein the modifying includes modifying the sequence of the plurality of geolocations; and presenting the modified route plan to the user.

In Example 16, the subject matter of any one or more of Examples 13-15 optionally include wherein each of the user intents comprises a geolocation and a purpose for visiting the geolocation.

In Example 17, the subject matter of Example 16 optionally includes wherein receiving selections of the plurality of the geolocations and user intents corresponding to the plurality of geolocations comprises receiving an indication of one or more of shopping, dining, sightseeing, photography, attending an appointment, and participating in a meeting.

In Example 18, the subject matter of any one or more of Examples 13-17 optionally include wherein the location data further includes points of interest associated with the geolocations, and wherein the location constraints include opening hours of the points of interest.

In Example 19, the subject matter of any one or more of Examples 13-18 optionally include wherein each of the user intents comprises a geolocation and a user constraint for visiting the geolocation.

In Example 20, the subject matter of Example 19 optionally includes wherein a user constraint for visiting a geolocation comprises one or more of a time constraint, a weather constraint, a presence constraint, a peak hours constraint, and a time to final destination constraint.

In Example 21, the subject matter of Example 20 optionally includes wherein a presence constraint indicates whether a person's presence at the geolocation is required or optional.

In Example 22, the subject matter of any one or more of Examples 20-21 optionally include wherein a peak hours constraint indicates whether a geolocation is to be visited during peak hours or off-peak hours.

In Example 23, the subject matter of any one or more of Examples 20-22 optionally include wherein a time constraint indicates whether an arrival time at a geolocation should be at, before, or after a specified time.

In Example 24, the subject matter of any one or more of Examples 20-23 optionally include wherein a weather constraint indicates a desired weather condition for visiting a geolocation.

In Example 25, the subject matter of any one or more of Examples 20-24 optionally include wherein a time to final destination indicates a desired arrival time at a final destination in the route.

In Example 26, the subject matter of any one or more of Examples 13-25 optionally include wherein retrieving the location data is performed in response to location search terms received via an input device.

Example 27 is at least one machine-readable medium including instructions, which when executed by a machine, cause the machine to perform operations of any of the methods of Examples 13-26.

Example 28 is an apparatus comprising means for performing any of the methods of Examples 13-26.

Example 29 is at least one machine-readable medium including instructions, which when executed by a machine, cause the machine to: retrieve location data including geolocations and location constraints associated with the geolocations; receive selections of a plurality of the geolocations and user intents corresponding to the plurality of geolocations; generate a route plan including a sequence of the plurality of geolocations, wherein the sequence is based at least in part on comparing the user intents to constraints associated with the plurality of geolocations; and present the route plan to a user.

In Example 30, the subject matter of Example 29 optionally includes wherein each of the user intents comprises a geolocation and a purpose for visiting the geolocation.

In Example 31, the subject matter of any one or more of Examples 29-30 optionally include wherein each of the user intents comprises a geolocation and a user constraint for visiting the geolocation, and wherein a user constraint for visiting a geolocation comprises one or more of a time constraint, a weather constraint, a presence constraint, a peak hours constraint, and a time to final destination constraint.

In Example 32, the subject matter of Example 31 optionally includes wherein: a presence constraint indicates whether a person's presence at the geolocation is required or optional; and a geolocation in the sequence of the plurality of geolocations having a presence constraint indicating that the user's presence is optional is removed from the route plan in response to determining that one or more user intents for another geolocation in the plurality of geolocations cannot be satisfied.

In Example 33, the subject matter of any one or more of Examples 31-32 optionally include wherein a peak hours constraint indicates whether a geolocation is to be visited during peak hours or off-peak hours.

In Example 34, the subject matter of any one or more of Examples 31-33 optionally include wherein a time constraint indicates whether an arrival time at a geolocation should be at, before, or after a specified time.

In Example 35, the subject matter of any one or more of Examples 31-34 optionally include wherein a weather constraint indicates a desired weather condition for visiting a geolocation.

In Example 36, the subject matter of any one or more of Examples 31-35 optionally include wherein a time to final destination indicates a desired arrival time at a final destination in the route.

In Example 37, the subject matter of any one or more of Examples 29-36 optionally include wherein retrieving the location data is performed in response to location search terms received via an input device.

Example 38 is an apparatus for navigation based on user intents, the apparatus comprising: means for retrieving location data including geolocations and location constraints associated with the geolocations; means for receiving selections of a plurality of the geolocations and user intents corresponding to the plurality of geolocations; means for generating a route plan including a sequence of the plurality of geolocations, wherein the sequence is based at least in part on comparing the user intents to constraints associated with the plurality of geolocations; and means for presenting the route plan to a user.

In Example 39, the subject matter of Example 38 optionally includes wherein each of the user intents comprises a geolocation and a purpose for visiting the geolocation.

In Example 40, the subject matter of Example 39 optionally includes wherein a purpose for visiting a geolocation comprises one or more of shopping, dining, sightseeing, photography, attending an appointment, and participating in a meeting.

In Example 41, the subject matter of any one or more of Examples 38-40 optionally include wherein the location data further includes points of interest associated with the geolocations, and wherein the location constraints include opening hours of the points of interests.

In Example 42, the subject matter of any one or more of Examples 38-41 optionally include wherein each of the user intents comprises a geolocation and a user constraint for visiting the geolocation.

In Example 43, the subject matter of Example 42 optionally includes wherein a user constraint for visiting a geolocation comprises one or more of a time constraint, a weather constraint, a presence constraint, a peak hours constraint, and a time to final destination constraint.

In Example 44, the subject matter of Example 43 optionally includes wherein a presence constraint indicates whether a person's presence at the geolocation is required or optional.

In Example 45, the subject matter of any one or more of Examples 43-44 optionally include wherein a peak hours constraint indicates whether a geolocation is to be visited during peak hours or off-peak hours.

In Example 46, the subject matter of any one or more of Examples 43-45 optionally include wherein a time constraint indicates whether an arrival time at a geolocation should be at, before, or after a specified time.

In Example 47, the subject matter of any one or more of Examples 43-46 optionally include wherein a weather constraint indicates a desired weather condition for visiting a geolocation.

In Example 48, the subject matter of any one or more of Examples 43-47 optionally include wherein a time to final destination indicates a desired arrival time at a final destination in the route.

In Example 49, the subject matter of any one or more of Examples 38-48 optionally include means for determining, after presenting the route plan to the user, whether one or more of the user intents cannot be satisfied by comparing the user intents to the location constraints associated with the plurality of geolocations; means for modifying the route plan in real-time in response to determining that one or more of the user intents cannot be satisfied, wherein the means for modifying includes means for modifying the sequence of the plurality of geolocations; and means for presenting the modified route plan to the user.

In Example 50, the subject matter of any one or more of Examples 38-49 optionally include means for modifying the route plan in real-time, after presenting the route plan to the user, in response to detecting a change in one or more of a traffic condition, an appointment in a calendar application, the user's mode of transport, availability of people at a location, and a weather condition, wherein the means for modifying includes means for modifying the sequence of the plurality of geolocations; and means for presenting the modified route plan to the user.

In Example 51, the subject matter of any one or more of Examples 38-50 optionally include wherein the means for retrieving the location data is configured to retrieve the location data in response to location search terms received via the means for receiving selections.

In Example 52, the subject matter of any one or more of Examples 38-51 optionally include wherein: the apparatus is an apparatus of an autonomous driving vehicle; the means for receiving selections of the plurality of the geolocations and user intents corresponding to the plurality of geolocations includes a user interface of the autonomous driving vehicle; and the means for presenting the route plan to the user includes an output device of the autonomous driving vehicle

In Example 53, the subject matter of any one or more of Examples 38-52 optionally include the user interface includes one or more of a touch pad, a touch screen, a microphone, and a camera of the autonomous driving vehicle; and the output device includes a display screen and an audio output device of the autonomous driving vehicle.

Example 54 is at least one machine-readable medium including instructions, which when executed by a machine, cause the machine to perform operations of any of the operations of Examples 1-53.

Example 54 is an apparatus comprising means for performing any of the operations of Examples 1-53.

Example 55 is a system to perform the operations of any of Examples 1-53.

Example 56 is a method to perform the operations of any of Examples 1-53.

### Additional Notes:

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A navigation system for generating a route plan based on user intents, the system comprising:
a search engine for retrieving location data, the location data including geolocations and location constraints associated with the geolocations;
an input device to receive selections of a plurality of the geolocations and user intents corresponding to the plurality of geolocations;
a route generator to generate a route plan including a sequence of the plurality of geolocations, wherein the sequence is based at least in part on comparing the user intents to constraints associated with the plurality of geolocations; and
a display device to present the route plan.

2. The system of claim 1, wherein each of the user intents comprises a geolocation and a purpose for visiting the geolocation.

3. The system of claim 2, wherein a purpose for visiting a geolocation comprises one or more of shopping, dining, sightseeing, photography, attending an appointment, and participating in a meeting.

4. The system of claim 1, wherein the location data further includes points of interest associated with the geolocations, and wherein the location constraints include opening hours of the points of interest.

5. The system of claim 1, wherein each of the user intents comprises a geolocation and a user constraint for visiting the geolocation.

6. The system of claim 5, wherein a user constraint for visiting a geolocation comprises one or more of a time constraint, a weather constraint, a presence constraint, a peak hours constraint, and a time to final destination constraint.

7. The system of claim 6, wherein a presence constraint indicates whether a person's presence at the geolocation is required or optional.

8. The system of claim 6, wherein a peak hours constraint indicates whether a geolocation is to be visited during peak hours or off-peak hours.

9. The system of claim 6, wherein a time constraint indicates whether an arrival time at a geolocation should be at, before, or after a specified time.

10. The system of claim 6, wherein a weather constraint indicates a desired weather condition for visiting a geolocation.

11. The system of claim 1, wherein the search engine retrieves the location data in response to location search terms received via the input device.

12. A method for navigation based on user intents, the method comprising:
retrieving location data including geolocations and location constraints associated with the geolocations;
receiving selections of a plurality of the geolocations and user intents corresponding to the plurality of geolocations;
generating a route plan including a sequence of the plurality of geolocations, wherein the sequence is based at least in part on comparing the user intents to location constraints associated with the plurality of geolocations; and
presenting the route plan to a user.

13. The method of claim 12, further comprising, after the presenting:
determining whether one or more of the user intents cannot be satisfied by comparing the user intents to the location constraints associated with the plurality of geolocations;
modifying the route plan in real-time in response to determining that one or more of the user intents cannot be satisfied, wherein the modifying includes modifying the sequence of the plurality of geolocations; and
presenting the modified route plan to the user.

14. The method of claim 12, wherein each of the user intents comprises a geolocation and a purpose for visiting the geolocation.

15. The method of claim 14, wherein receiving the purpose for visiting the corresponding geolocation comprises receiving an indication of one or more of shopping, dining, sightseeing, photography, attending an appointment, and participating in a meeting.

16. The method of claim 12, wherein the location data further includes points of interest associated with the geolocations, and wherein the location constraints include opening hours of the points of interest.

17. The method of claim 12, wherein each of the user intents comprises a geolocation and a user constraint for visiting the geolocation.

18. The method of claim 17, wherein a user constraint for visiting a geolocation comprises one or more of a time constraint, a weather constraint, a presence constraint, a peak hours constraint, and a time to final destination constraint, the method further comprising, after the presenting:
modifying the route plan in real-time in response to detecting a change in one or more of a traffic condition, an appointment in a calendar application, the user's mode of transport, availability of people at a location, and a weather condition, wherein the modifying includes modifying the sequence of the plurality of geolocations; and
presenting the modified route plan to the user.

19. At least one machine-readable medium including instructions, which when executed by a machine, cause the machine to:
retrieve location data including geolocations and location constraints associated with the geolocations;
receive selections of a plurality of the geolocations and user intents corresponding to the plurality of geolocations;
generate a route plan including a sequence of the plurality of geolocations, wherein the sequence is based at least in part on comparing the user intents to constraints associated with the plurality of geolocations; and
present the route plan to a user.

20. The at least one machine-readable medium of claim 19, wherein each of the user intents comprises a geolocation and a purpose for visiting the geolocation.

21. The at least one machine-readable medium of claim 19, wherein each of the user intents comprises a geolocation and a user constraint for visiting the geolocation, and wherein a user constraint for visiting a geolocation comprises one or more of a time constraint, a weather constraint, a presence constraint, a peak hours constraint, and a time to final destination constraint.

22. The at least one machine-readable medium of claim 21, wherein:
a presence constraint indicates whether a person's presence at the geolocation is required or optional; and
a geolocation in the sequence of the plurality of geolocations having a presence constraint indicating that the user's presence is optional is removed from the route plan in response to determining that one or more user intents for another geolocation in the plurality of geolocations cannot be satisfied.

23. The at least one machine-readable medium of claim 21, wherein a peak hours constraint indicates whether a geolocation is to be visited during peak hours or off-peak hours.

24. The at least one machine-readable medium of claim 20, wherein a time constraint indicates whether an arrival time at a geolocation should be at, before, or after a specified time.

25. The at least one machine-readable medium of claim 20, wherein a weather constraint indicates a desired weather condition for visiting a geolocation.
